(19) United States
(12) Patent Application Publication
(10) Pub. No.: US 2006/0147094 A1
(43) Pub. Date: Jul. 6, 2006

(54) Pupil detection method and shape descriptor extraction method for a iris recognition, iris feature extraction apparatus and method, and iris recognition system and method using its

(76) Inventor: Woong-Tuk Yoo, Seoul (KR)

Correspondence Address: MAYER, BROWN, ROWE & MAW LLP, 1909 K STREET, N.W., WASHINGTON, DC, 20006, US

(21) Appl. No.: 10/559,831

(22) PCT Filed: Sep. 8, 2004
(86) PCT No.: PCT/KR04/02285

§ 371 Date: Dec. 6, 2005

(30) Foreign Application Priority Data
Sep. 8, 2003 (KR) 10-2003-0062537

(51) Int. Cl. G06K 9/00

(52) U.S. Cl. 382/117

(57) ABSTRACT

Provided is pupil detection method and shape descriptor extraction method for an iris recognition, iris feature extraction apparatus and method, and iris recognition system and method using the same. The method for detecting a pupil for iris recognition, includes the steps of: a) detecting light sources in the pupil from an eye image as two reference points; b) determining first boundary candidate points located between the iris and the pupil of the eye image, which cross over a straight line between the two reference points; c) determining second boundary candidate points located between the iris and the pupil of the eye image, which cross over a perpendicular bisector of a straight line between the first boundary candidate points; and d) determining a location and a size of the pupil by obtaining a radius of a circle and coordinates of a center of the circle based on a center candidate point, wherein the center candidate point is a center point of perpendicular bisectors of straight line between the neighbor boundary candidate points, to thereby detect the pupil.

### TECHNICAL FIELD

The present invention relates to a biometric technology based on a pattern recognition and a image processing; and, more particularly, to a pupil detection method and a shape descriptor extraction method for an iris recognition that can provide a personal identification based on an iris of an eye, an iris feature extraction apparatus and method and iris recognition system and method using the same, and a computer-readable recording medium that records programs implementing the methods.

### BACKGROUND ART

Conventional methods for identifying a person, e.g., a password and a personal identification number, cannot provide accurate and reliable personal identification in an information society that is getting highly developed, due to stealth or lost of the password and the identification number, and cause side effects according to a reverse function.

Particularly, it is predictable that rapid development of an internet environment and increase of the electronic commercial cause enormous mental blow and material damage to a personal or an organization using only those conventional identification method.

Since among various biometric methods, the iris is broadly known as most effective in a view of identity, invariance and stability, and a failure rate of the recognition is very low, the iris is applied to a field that requires high security.

Generally, in method for identifying a person using the iris, it is indispensable to detect speedily a pupil and the iris for real-time iris recognition from an image signal of an eye of the person.

Hereinafter, features of the iris and a conventional method for the iris recognition will be described.

In a process for precisely dividing the pupil from the iris by detecting a pupil boundary, it is very important to achieve a feature point and a normalized feature quantity regardless of a pupillary dilation without allocating the same part of the iris analysis region to the same coordinates when the image is analyzed.

Also, the feature point of the iris analysis region reflects an iris fiber, a structure of layers and a defection of a connection state. Because the structure affects to a function and reflects integrity, the structure indicates a resistance of an organic and a genetic factor. As related signs, there are lacunae, crypts, defect signs and rarifition and so on.

The pupil is located in the middle of the iris and iris collarette that is an iris frill having a sawtooth shape, i.e., autonomic nerve wreath in the iridology, is located at 1-2 mm distance from a pulillary. Inside of the collarette is an annuls iridis minor and outside of the collarette is an annuls iridis major. The annulus iridis major includes iris furrows that are a ring-shape prominence concentric to the pulillary. The iris furrows are referred to as a nerve ring in the iridology.

In order to use an iris pattern based on a clinical experience of the iridology as the feature point, the iris analysis region is divided into 13 sectors and each sector is subdivided into 4 circular regions based on a center of the pupil.

The iris recognition system extracts an image signal from the iris, transforms the image signal to specialized iris data, searches identical data to the specialized iris data in a database and compares the searched data to the specialized iris data, to thereby identify the person for acceptance or refusal.

It is important to search a statistical texture, i.e., an iris shape, in the iris recognition system. Features that a person recognizes the texture are periodicity, directionality and randomness in a cognitive science. Statistical feature of the iris includes the degree of freedom and sufficient identity to identify a person. An individual can be identified based on the statistical feature.

Generally, in the conventional pupil extraction method of the conventional iris recognition system proposed by Daugman, a circular projection is obtained at every location of the image and a differential value of the circular projection is calculated, and then the largest value obtained by calculating the differential value based on Gaussian convolution is estimated as the boundary. Then, a location that the circular boundary component is the strongest is obtained based on the estimated boundary, to thereby extract the pupil from the iris image.

However, it takes long time to extract the pupil because the projection for the whole image and the differential calculation increase operation numbers. Because it assumed that there is a circular component, it cannot be detected that there is no circular component in the conventional method.

Also, the pupil detection must be processed before the iris recognition, and fast pupil extraction is required for real-time iris recognition. However, if a light source exists in the pupil, an inaccurate pupil boundary is detected due to infrared rays. Because the above problem, the iris analysis region must be whole image except light origin region. Therefore, the accuracy of the analysis is decreased.

In particular, a method for dividing a frequency region based on a filter bank and extracting the statistical feature is generally used in the iris feature extraction. Gabor filter or Wavelet filter is used. The Gabor filter can divide the frequency region effectively, and the Wavelet filter can divide the frequency region on consideration of a human eyesight feature. However, because the above methods require many operations, i.e., it needs much time, the above methods are not appropriate for the iris recognition system. In detail, because much time and cost are needed to develop the iris recognition system and the recognition operation cannot be operated rapidly, the method for extracting the statistical feature is not effective. Also, because the feature value is not rotation-invariant or scale-invariant, there is a limitation that the feature value is rotated and compared in order to search the converted texture.

However, in the case of the shape, it is possible to search the boundary by expressing in direction, and to express and search the shape of the image regardless of change, motion, rotation and scale of the shape by using various transformations. Therefore, it is desirable to preserve an iris boundary shape or an efficient feature of a part of the iris.

A shape descriptor is based on a lower abstraction level description that can be automatically extracted, and is a basic descriptor that human can indicate from the image. There are two well-known shape descriptors adopted by experiment model (XM) that is a standard of Motion Picture Expert Group-7 (MPEG-7). The first shape descriptor is Zernike moment shape descriptor. A Zernike basis function is prepared in order to get distribution of various shapes in the image and the image having a predetermined sized is projected to the basis function, and the projected value is used as the Zernike moment shape descriptor. The second shape descriptor is Curvature scale space descriptor. A low frequency-pass filtering of the contour extracted from the image is performed, a change of inflection point existing on the contour is expressed in a scale space, and a peak value and the location of the inflection point are expressed as a two-dimensional vector. The two-dimensional vector is used as a Curvature scale space descriptor.

Also, according to an image matching method using the conventional shape descriptor, a precise object must be extracted from the image in order to search a model image having the shape descriptor similar with the shape descriptor of a query image. Therefore, it is a drawback that the model image cannot be searched if the object is not extracted precisely.

Therefore, it is required that a method for developing similar group database indexed based on a similarity shape descriptor, e.g., the Zernike moment shape descriptor or the Curvature scale space shape descriptor, and searching an indexed iris group having similar shape descriptor with the query image from the database. In particular, the above method is very effective to 1:N identification (N is a natural number).

### DISCLOSURE

Technical Problem of the Invention

It is, therefore, an object of the present invention to provide a method for extracting a pupil in real time and an iris feature extraction apparatus using the same for the iris recognition that is not sensitive to illumination lighting to an eye and has high accuracy, and a computer-readable recording medium recording a program that implements the methods.

Also, it is another object of the present invention to provide a method for extracting a shape descriptor which is invariant to motion, scale, illumination and rotation, a method for developing a similar group database indexed by using the shape descriptor and searching the index iris group having a similar shape descriptor with the query image from the database, and an iris feature extracting apparatus using the same, an iris recognition system and a method thereof, and a computer-readable recording medium recording a program that implements the methods.

Also, it is still another object of the present invention to provide a method for developing an iris shape database according to a dissimilar shape descriptor by measuring dissimilarity of a similar iris shape group indexed by the shape descriptor extracted by a linear shape descriptor extraction method and searching the index iris group having the shape descriptor matched to the query image from the database, and an iris feature extracting apparatus using the same, an iris recognition system and a method thereof, and a computer-readable recording medium recording a program that implements the methods.

Other objects and benefits of the present invention will be described hereinafter, and will be recognized according to an embodiment of the present invention. Also, the objects and the benefits of the present invention can be implemented in accordance with means and combinations shown in claims of the present invention.

Technical Solution of the Invention

In accordance with an aspect of the present invention, there is provided a method for detecting a pupil for iris recognition, including the steps of: a) detecting light sources in the pupil from an eye image as two reference points; b) determining first boundary candidate points located between the iris and the pupil of the eye image, which cross over a straight line between the two reference points; c) determining second boundary candidate points located between the iris and the pupil of the eye image, which cross over a perpendicular bisector of a straight line between the first boundary candidate points; and d) determining a location and a size of the pupil by obtaining a radius of a circle and coordinates of a center of the circle based on a center candidate point, wherein the center candidate point is a center point of perpendicular bisectors of straight line between the neighbor boundary candidate points, to thereby detect the pupil.

In accordance with another aspect of the present invention, there is provided a method for extracting a shape descriptor for iris recognition, the method including the steps of: a) extracting features of an iris under a scale-space and/or a scale illumination; b) normalizing a low-order moment with a mean size and/or a mean illumination, to thereby generate a Zernike moment which is size-invariant and/or illumination-invariant, based on the low-order moment; and c) extracting a shape descriptor which is rotation-invariant, size-invariant and/or illumination-invariant, based on the Zernike moment.

The above method further includes the steps of: establishing an indexed iris shape grouping database based on the shape descriptor; and retrieving an indexed iris shape group based on an iris shape descriptor similar to that of a query image from the indexed iris shape grouping database.

In accordance with another aspect of the present invention, there is provided a method for extracting a shape descriptor for iris recognition, the method including the steps of: a) extracting a skeleton from the iris; b) thinning the skeleton, extracting straight lines by connecting pixels in the skeleton, obtaining a line list; and c) normalizing the line list and setting the normalized line list as a shape descriptor.

The above method further includes the steps of: establishing an iris shape database of dissimilar shape descriptor by measuring dissimilarity of the images in an indexed similar iris shape group based on the shape descriptor; and retrieving an iris shape matched to a query image from the iris shape database.

In accordance with another aspect of the present invention, there is provided an apparatus for extracting a feature of iris, including: image capturing unit for digitalizing and quantizing an image and obtaining an appropriate image for iris recognition; reference point detecting unit for detecting reference points in a pupil from the image, and detecting an actual center point of the pupil; boundary detecting unit for detecting an inner boundary between the pupil and the iris and an outer boundary between the iris and a sclera, to thereby extract an iris image from the image; image coordinates converting unit for converting a coordinates of the iris image from a Cartesian coordinates system to a polar coordinates system, and defining the center point of the pupil as an origin point of the polar coordinates system; image analysis region defining unit for classifying analysis regions of the iris image in order to use an iris pattern as a feature point based on clinical experiences of the iridology; image smoothing unit for smoothing the image by performing a scale space filtering of the analysis region of the iris image in order to clearly distinguish a brightness distribution difference between neighboring pixels of the image; image normalizing unit for normalizing a low-order moment used for the smoothen image as a mean size; and shape descriptor extracting unit for generating a Zernike moment based on the feature point extracted in a scale space and a scale illumination, and extracting a shape descriptor which is rotation-invariant and noise-resistant by using Zernike moment.

The above apparatus further includes reference value storing unit for storing a reference value as a template by comparing a stability of the Zernike moment and a similarity of Euclid distance.

In accordance with another aspect of the present invention, there is provided a system for recognizing an iris, including: image capturing unit for digitalizing and quantizing an image and obtaining an appropriate image for iris recognition; reference point detecting unit for detecting reference points in a pupil from the image, and detecting an actual center point of the pupil; boundary detecting unit for detecting an inner boundary between the pupil and the iris and an outer boundary between the iris and a sclera, to thereby extract an iris image from the image; image coordinates converting unit for converting a coordinates of the iris image from a Cartesian coordinates system to a polar coordinates system, and defining the center point of the pupil as an origin point of the polar coordinates system; image analysis region defining unit for classifying analysis regions of the iris image in order to use an iris pattern as a feature point based on clinical experiences of the iridology; image smoothing unit for smoothing the image by performing a scale space filtering of the analysis region of the iris image in order to clearly distinguish a brightness distribution difference between neighboring pixels of, the image; image normalizing unit for normalizing a low-order moment used for the smoothen image as a mean size; shape descriptor extracting unit for generating a Zernike moment based on the feature point extracted in a scale space and a scale illumination, and extracting a shape descriptor which is rotation-invariant and noise-resistant by using Zernike moment; reference value storing unit for storing a reference value as a template by comparing a stability of the Zernike moment and a similarity of Euclid distance; and verifying/authenticating unit for verifying/authenticating the iris by matching the feature quantities between models each of which represent the stability and the similarity of the Zernike moment of the query iris image in statistical.

In accordance with another aspect of the present invention, there is provided a method for extracting a feature of an iris, including the steps of: a) digitalizing and quantizing an image and obtaining an appropriate image for iris recognition; b) detecting reference points in a pupil from the image, and detecting an actual center point of the pupil; c) detecting an inner boundary between the pupil and the iris and an outer boundary between the iris and a sclera, to thereby extract an iris image from the image; d) converting a coordinates of the iris image from a Cartesian coordinates system to a polar coordinates system, and defining the center point of the pupil as an origin point of the polar coordinates system; e) classifying analysis regions of the iris image in order to use an iris pattern as a feature point based on clinical experiences of the iridology; f) smoothing the image by performing a scale space filtering of the analysis region of the iris image in order to clearly distinguish a brightness distribution difference between neighboring pixels of the image; g) normalizing the image by normalizing a low-order moment with a mean size, wherein the low-order moment is used for the smoothen image; and h) generating a Zernike moment based on the feature point extracted in a scale space and a scale illumination, and extracting a shape descriptor which is rotation-invariant and noise-resistant by using Zernike moment.

The above method further includes the step of i) storing a reference value as a template by comparing a stability of the Zernike moment and a similarity of Euclid distance.

In accordance with another aspect of the present invention, there is provided a method for recognizing an iris, including the steps of: a) digitalizing and quantizing an image and obtaining an appropriate image for iris recognition; b) detecting reference points in a pupil from the image, and detecting an actual center point of the pupil; c) detecting an inner boundary between the pupil and the iris and an outer boundary between the iris and a sclera, to thereby extract an iris image from the image; d) converting a coordinates of the iris image from a Cartesian coordinates system to a polar coordinates system, and defining the center point of the pupil as an origin point of the polar coordinates system; e) classifying analysis regions of the iris image in order to use an iris pattern as a feature point based on clinical experiences of the iridology; f) smoothing the image by performing a scale space filtering of the analysis region of the iris image in order to clearly distinguish a brightness distribution difference between neighboring pixels of the image; g) normalizing the image by normalizing a low-order moment with a mean size, wherein the low-order moment is used for the smoothen image; h) generating a Zernike moment based on the feature point extracted in a scale space and a scale illumination, and extracting a shape descriptor which is rotation-invariant and noise-resistant by using Zernike moment; i) storing a reference value as a template by comparing a stability of the Zernike moment and a similarity of Euclid distance; and j) verifying/authenticating the iris by matching the feature quantities between models each of which represent the stability and the similarity of the Zernike moment of the query iris image in statistical.

In accordance with another aspect of the present invention, there is provided a computer readable recording medium storing program for executing a method for detecting a pupil for iris recognition, the method including the steps of: a) detecting light sources in the pupil from an eye image as two reference points; b) determining first boundary candidate points located between the iris and the pupil of the eye image, which cross over a straight line between the two reference points; c) determining second boundary candidate points located between the iris and the pupil of the eye image, which cross over a perpendicular bisector of a straight line between the first boundary candidate points; and d) determining a location and a size of the pupil by obtaining a radius of a circle and coordinates of a center of the circle based on a center candidate point, wherein the center candidate point is a center point of perpendicular bisectors of straight line between the neighbor boundary candidate points, to thereby detect the pupil.

In accordance with another aspect of the present invention, there is provided a computer readable recording medium storing program for executing a method for extracting a shape descriptor for iris recognition, the method including the steps of: a) extracting a feature of iris under a scale-space and/or a scale illumination; b) normalizing a low-order moment with a mean size and/or a mean illumination, to thereby generate a Zernike moment which is size-invariant and/or illumination-invariant, based on the low-order moment; and c) extracting a shape descriptor which is rotation-invariant, size-invariant and/or illumination-invariant, based on the Zernike moment.

The above computer readable recording medium further includes the steps of: establishing an indexed iris shape grouping database based on the shape descriptor; and retrieving an indexed iris shape group based on an iris shape descriptor similar to that of a query image from the indexed iris shape grouping database.

In accordance with another aspect of the present invention, there is provided a computer readable recording medium storing program for executing a method for extracting a shape descriptor for iris recognition, the method including the steps of: a) extracting a skeleton from the iris; b) thinning the skeleton, extracting straight lines by connecting pixels in the skeleton, obtaining a line list; and c) normalizing the line list and setting the normalized line list as a shape descriptor.

The above computer readable recording medium further includes the steps of: establishing an iris shape database of dissimilar shape descriptor by measuring dissimilarity of the images in an indexed similar iris shape group based on the shape descriptor; and retrieving an iris shape matched to a query image from the iris shape database.

In accordance with another aspect of the present invention, there is provided a computer readable recording medium storing program for executing a method for extracting a feature of iris, the method including the steps of: a) digitalizing and quantizing an image and obtaining an appropriate image for iris recognition; b) detecting reference points in a pupil from the image, and detecting an actual center point of the pupil; c) detecting an inner boundary between the pupil and the iris and an outer boundary between the iris and a sclera, to thereby extract an iris image from the image; d) converting a coordinates of the iris image from a Cartesian coordinates system to a polar coordinates system, and defining the center point of the pupil as an origin point of the polar coordinates system; e) classifying analysis regions of the iris image in order to use an iris pattern as a feature point based on clinical experiences of the iridology; f) smoothing the image by performing a scale space filtering of the analysis region of the iris image in order to clearly distinguish a brightness distribution difference between neighboring pixels of the image; g) normalizing the image by normalizing a low-order moment with a mean size, wherein the low-order moment is used for the smoothen image; and h) generating a Zernike moment based on the feature point extracted in a scale space and a scale illumination, and extracting a shape descriptor which is rotation-invariant and noise-resistant by using Zernike moment.

The above computer readable recording medium further includes the step of: i) storing a reference value as a template by comparing a stability of the Zernike moment and a similarity of Euclid distance.

In accordance with another aspect of the present invention, there is provided a computer readable recording medium which is recorded program for executing a method for recognizing an iris, the method including the steps of: a) digitalizing and quantizing an image and obtaining an appropriate image for iris recognition; b) detecting reference points in a pupil from the image, and detecting an actual center point of the pupil; c) detecting an inner boundary between the pupil and the iris and an outer boundary between the iris and a sclera, to thereby extract an iris image from the image; d) converting a coordinates of the iris image from a Cartesian coordinates system to a polar coordinates system, and defining the center point of the pupil as an origin point of the polar coordinates system; e) classifying analysis regions of the iris image in order to use an iris pattern as a feature point based on clinical experiences of the iridology; f) smoothing the image by performing a scale space filtering of the analysis region of the iris image in order to clearly distinguish a brightness distribution difference between neighboring pixels of the image; g) normalizing the image by normalizing a low-order moment with a mean size, wherein the low-order moment is used for the smoothen image; h) generating a Zernike moment based on the feature point extracted in a scale space and a scale illumination, and extracting a shape descriptor which is rotation-invariant and noise-resistant by using Zernike moment; i) storing a reference value as a template by comparing a stability of the Zernike moment and a similarity of Euclid distance; and j) verifying/authenticating the iris by matching the feature quantities between models each of which represent the stability and the similarity of the Zernike moment of the query iris image in statistical.

The present invention provides an identification system which identifies a person or discriminate the person from others based on the iris of an eye quickly and precisely. The identification system acquires an iris pattern image for iris recognition, detects an iris and a pupil quickly for real-time iris recognition, extracts the unique features of the iris pattern by solving the problems of a non-contact iris recognition method, i.e., variation in the image size, tilting and moving, and utilizes the Zernike moment having the visional recognition ability of a human being, regardless of motion, scale, illumination and rotation.

For the identification system, the present invention acquires an image appropriate for the iris recognition by computing the brightness of an eyelid area and the pupil location based on the iris pattern image, performs diffusion filtering in order to remove noise in the edge area of an iris pattern image obtained by carrying out Gaussian blurring, and detects the pupil in real-time more quickly by using a repeated threshold value changing method. Since pupils have a different curvature, their radiuses are obtained by using a Magnified Greatest Coefficient method. Also, the central coordinates of a pupil is obtained by using a bisection method and then the distance from the center of the pupil to the radius of the pupil is obtained in the counter clock-wise. Subsequently, the precise boundary is detected by taking the x-axis as a rotational angle and the y-axis as a distance from the center to the radius of the pupil and expressing the result in a graph.

Also, the iris features are extracted through a scale-space filtering. Then, the Zernike moment having an invariant feature is generated by using a low-order moment and the low-order moment is normalized with a mean size in order-to obtain features that are not changed by the size, illumination and rotation. The Zernike moment is stored as a reference value. The identification system recognizes/identifies an object in the input image through a feature quantity matching between models reflecting the similarity of the reference value, the stability of the Zernike moment of the input image, and the feature quantity in probabilities. Herein, the identification system can identify an iris of a living person quickly and clearly by combining the Least Square (LS) and Least Media of Square (Lmed) algorithms.

To be more specific, the present invention directly acquires a digitalized eye image by using a digital camera instead of using a general video camera for identification, selects an eye image appropriate for recognition, detects a reference point within a pupil, defining a boundary between the iris and the pupil of the eye, and then defining another circular boundary between the iris and a sclera by using an arc that does not necessarily form a concentric circle with the pupil boundary. In other words, the identification system directly acquires a digitalized eye image by using a digital camera instead of a general video camera for identification, selects an eye image appropriate for recognition, detects a reference point within the pupil, detecting a pupil boundary between the iris and the pupil of the eye, detecting a pupil region by acquiring the center coordinates and the radius of the circle and determining the location and size of the pupil, and detects an external area between the iris region and the sclera region by using an arc that does not necessarily form a concentric circle with the pupil boundary.

A polar coordinate system is established and the center of the circular pupil boundary of the iris pattern image is put in the origin of the polar coordinate system. Then, an annular analysis region is defined within the iris. The analysis region appropriate for recognition does not include pre-selected parts, e.g., the eyelid, the eyelashes or a part can be blocked off by mirror reflection from illumination. The iris pattern image in the analysis region is transformed into a polar coordinate system and goes through 1-order scale-space filtering that provides the same pattern regardless of the size of the iris pattern image by using a Gaussian kernel with respect to a one-dimensional iris pattern image of the same radiuses around the pupil. Then, an edge, which is a zero-crossing point, is obtained, and the iris features are extracted in two-dimensional by accumulating the edge by using an overlapped convolution window. This way, the size of data can be reduced during the generation of an iris code. Also, the extracted iris features can make a size-invariant Zernike moment which is rotation-invariant but sensitive to size and illumination as normalizing the moment into a mean size by using the low-order moment in order to obtain a feature quantity. If a change in a local illumination is modeled into a scale illumination change and the moment is normalized into a mean brightness, an illumination-invariant Zernike moment can be generated. A Zernike moment is generated based on the feature point extracted from the scale space and scale illumination and stored as a reference value. At a recognition part, an object in the iris image is identified by matching the feature quantity between models reflecting the reference value, stability of the Zernike moment and similarity between feature quantities in probability. Wherein, the iris recognition is verified by combining the LS and the Lmeds methods.

In accordance with the present invention, the feature quantity that is invariant to a local illumination change is generated by changing a local Zernike moment based on biological facts that a person focuses at the main feature point when a person recognize the object. Therefore, an image of the eye must be acquired as a digital form appropriate to analyze. Then, an iris region of the image is defined and separated. The defined region of the iris image is analyzed, and to thereby generate the iris feature. A moment based on the feature generated for a specific iris is generated and stored as a reference value. In order to obtain an outlier, the moment of the input image is filtered using the similarity and the stability used for probability object recognition and then is matched to the stored reference moment. The outlier allows the system to confirm or disconfirm the identification of the person and evaluate confirm level of the decision. Also, a recognition rate can be obtained by discriminative factor (DF), which has the high recognition performance when matching number between the input image and the right model is more than a matching number between the input image and the wrong model.

Advantageous Effect

The present invention has an effect to increase recognition performance of the iris recognition system and to reduce processing time for iris recognition, because the iris recognition system can obtain an iris image appropriate for the iris recognition more effectively.

The present invention detects a boundary between the pupil and the iris of an eye quickly and precisely, and extracts the unique features of the iris pattern by solving the problems of a non-contact iris recognition method, i.e., variation in the image size, tilting and moving, and detects a texture (iris pattern) by utilizing the Zernike moment having the visional recognition ability of a human being, regardless of motion, scale, illumination and rotation.

In the present invention, an object in the iris image is identified by matching the feature quantity between models reflecting the reference value based on stability of the Zernike moment and similarity between feature quantities in probability, and the iris recognition is verified by combining the LS and the Lmeds methods, to thereby authenticate the iris of the human being in rapid and precise.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing an apparatus for extracting an iris feature and a system using the same in accordance with an embodiment of the present invention;

FIG. 2 is a detail block diagram showing an apparatus for extracting an iris feature of FIG. 1 in accordance with an embodiment of the present invention;

FIG. 3 is a flowchart describing a method for extracting an iris feature and a method for recognizing an iris using the same in accordance with an embodiment of the present invention;

FIG. 4 is a diagram showing an appropriate iris image for the iris recognition;

FIG. 5 is a diagram showing an inappropriate iris image for the iris recognition;

FIG. 6 is a flowchart showing a process for selecting an image at an image capturing unit in accordance with an embodiment of the present invention;

FIG. 7 is a graph showing a process for detecting an edge by using a 1-order differential operator in accordance with an embodiment of the present invention;

FIG. 8 is a diagram showing a process for modulating connection number for thinning in accordance with an embodiment of the present invention;

FIG. 9 is a diagram showing a feature rate of neighboring pixels for connecting a boundary in accordance with an embodiment of the present invention;

FIG. 10 is a diagram showing a process for determining a center of the pupil in accordance with an embodiment of the present invention;

FIG. 11 is a diagram showing a process for determining a radius of the pupil in accordance with an embodiment of, the present invention;

FIG. 12 is graphs showing a curvature graph and a model of an image in accordance with an embodiment of the present invention;

FIG. 13 is a graph showing a process for transforming the image by using a linear interpolation in accordance with an embodiment of the present invention;

FIG. 14 is a graph showing a linear interpolation in accordance with an embodiment of the present invention;

FIG. 15 is a diagram showing a process for transforming a Cartesian coordinates system into a polar coordinates system in accordance with an embodiment of the present invention;

FIG. 16 is a graph showing a Cartesian coordinates in accordance with an embodiment of the present invention;

FIG. 17 is a graph showing a plane polar coordinates in accordance with an embodiment of the present invention;

FIG. 18 is a graph showing a relation of zero-crossing points of first and second derivatives in accordance with an embodiment of the present invention;

FIG. 19 is a graph showing a connection of zero-crossing points in accordance with an embodiment of the present invention;

FIG. 20 is a diagram showing structures of a node and a graph of a two-dimensional histogram in accordance with an embodiment of the present invention;

FIG. 21 is a diagram showing a consideration when a transcendental probability is given in accordance with an embodiment of the present invention;

FIG. 22 is a diagram showing a sensitivity of a Zernike moment in accordance with an embodiment of the present invention;

FIG 23 is a graph showing first and second ZMMs of an input image on a two dimensional plane in accordance with an embodiment of the present invention;

FIG. 24 is a diagram showing method for matching local regions in accordance with an embodiment of the present invention;

FIG. 25 is a diagram showing a False Rejection Rate (FRR) and a False Acceptance Rate (FAR) according to a distribution curve in accordance with an embodiment of the present invention;

FIG. 26 is a graph showing a distance distribution chart of an iris for an identical person in accordance with an embodiment of the present invention;

FIG. 27 is a graph showing a distance distribution chart of an iris for another person in accordance with an embodiment of the present invention;

FIG. 28 is a graph showing an authentic distribution and an imposer distribution in accordance with an embodiment of the present invention; and

FIG. 29 is a graph showing a decision of Equal Error Rate (EER) in accordance with an embodiment of the present invention.

### MODES FOR INVENTION

The above and other objects and features of the present invention will become apparent from the following description, and thereby one of ordinary skill in the art can embody the principles of the present invention and invent various apparatuses within the concept and scope of the present invention. In addition, if further detailed description on the related prior arts is determined to blur the point of the present invention, the detail description shall be omitted. Hereafter, preferred embodiments of the present invention will be described in detail with reference to the drawings.

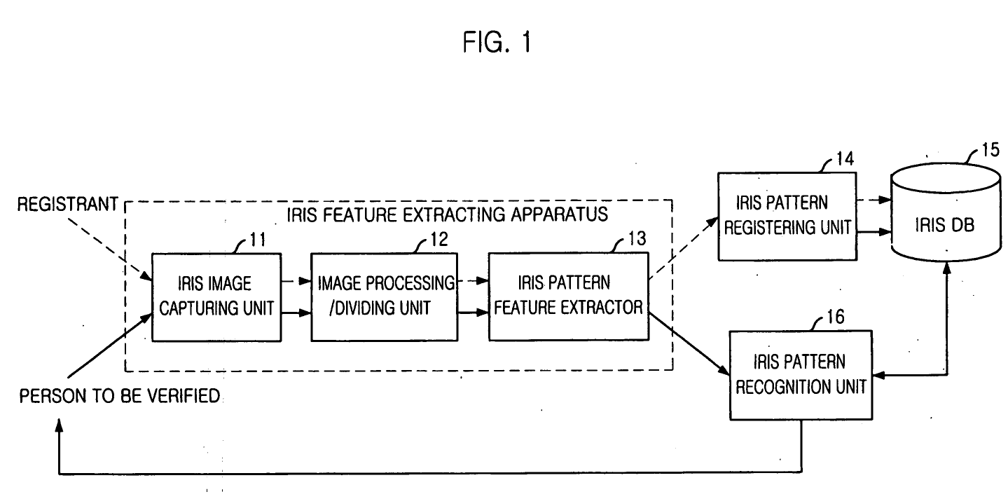

FIG. 1 is a block diagram showing an iris recognition system in accordance with an embodiment of the present invention.

The iris recognition system includes basically an illumination (not shown), a camera for capturing an image, e.g., desirably a digital camera (not shown), and can operates in a computer environment having such as a memory and a central processing unit (CPU).

The iris recognition system extracts features of an iris of a person by using an iris feature extracting apparatus having an iris image capturing unit 11, an image processing/dividing (fabricating) unit 12 and an iris pattern feature extractor 13, and the iris feature is used for a verifying process of the person at an iris pattern registering unit 14 and an iris pattern recognition unit 16.

At an initial time, a user must store feature data of its own iris in an iris database (DB) 15 and the iris pattern registering unit 14 registers the feature data. When verification is required later on, the user is required to identify him by capturing the iris using a digital camera, and then the iris pattern recognition unit 16 verifies the user.

When the iris pattern recognition unit 16 verifies, the captured iris feature is compared to the iris pattern of the user stored in the iris DB 15. When the verification is successful, the user can use the predetermined services. When the verification is failed, the user is decided as an unregistered person or an illegal service user.

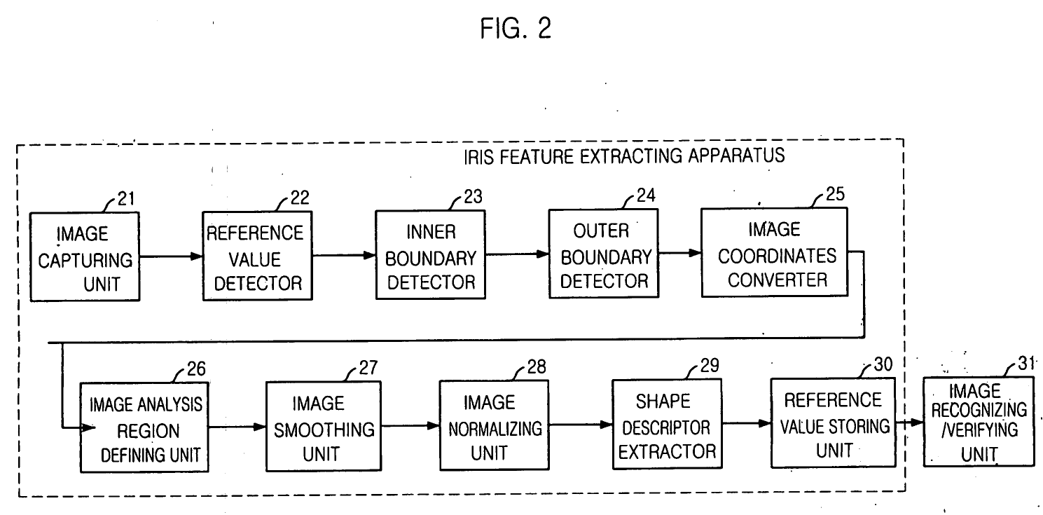

Detail structure of the iris feature extracting apparatus is as followings. As shown in FIG. 2, the iris extracting apparatus includes an image capturing unit 21, a reference point detector 22, an inner boundary detector 23, an outer boundary detector 24, an image coordinates converter 25, an image analysis region defining unit 26, an image smoothing unit 27, an image normalizing unit 28, a shape descriptor extractor 29 and a reference value storing unit 30 and an image recognizing/verifying unit 31.

The image capturing unit 21 digitalizes and quantizes an inputted image, and achieves an appropriate image for the iris recognition by detecting an eye blink and a location of a pupil and analyzing a distribution of vertical edge components. The reference point detector 22 detects any reference point of the pupil from the acquired image and to thereby detect an actual center point of the pupil. The inner boundary detector 23 detects an inner boundary wherein the pupil boundary on the iris. The outer boundary detector 24 detects an outer boundary wherein the iris borders on a sclera. The image coordinates converter 25 converts a Cartesian coordinates system of a divided iris pattern image into a polar coordinates system and defines an origin of the coordinates as a center of a circular pupil boundary. The image analysis region defining unit 26 classifies analysis regions of the iris image in order to uses the iris pattern defined based on clinical experiences of the iridology. The image smoothing unit 27 smoothes the image by filtering the analysis region of the iris image based on scale space in order to clearly distinguish a brightness distribution difference between neighboring pixels of the image. The image normalizing unit 28 normalizes a low-order moment with a mean size, wherein the low-order moment is used for the smoothen image. The shape descriptor extractor 29 generates a Zernike moment based on the feature point extracted from the scale space and the scale illumination and extracts a rotation-invariant and noise-resistant by using Zernike moment shape descriptor. Also, the reference value storing unit 30 (i.e., the iris pattern registering unit 14 and the iris DB of FIG. 1) stores a reference value as a template form by comparing stability of the Zernike moment to a similarity of Euclid distance, wherein the image pattern is projected into 25 spaces.

The image analysis region defining unit 26 is not an element included in the process of the iris recognition. The image analysis region defining unit 26 is included in the figure for the reference and shows that the feature point is extracted based on the iridology. The analysis region means the analysis region of the image appropriate for recognizing the iris that does not includes an eyelid, eyelashes or any predetermined part of the iris to be intercepted by the mirror reflection from an illumination.

Accordingly, the iris recognition system extracts the feature of the iris of the specific person by using the iris feature extracting apparatus 21 to 29, and recognizes the iris image i.e., identifies the specific person by matching the feature quantity between the reference value (the template) and a model reflecting stability and similarity of the Zernike moment of the iris image at the image recognizing/verifying unit 31 (i.e., the iris pattern recognition unit 16 of FIG. 1).

In particular, the inner boundary detector 23 and the outer boundary detector 24 detect two reference points from a light source of the illumination, i.e., desirably infrared, from the eye image, determine a candidate pupil boundary point, determine a pupil location and a pupil size by obtaining a radius of a circle and a center point of a circle that are close to the candidate pupil boundary based on the candidate center point, and to thereby detect the pupil region in real-time. In other word, the inner boundary detector 23 and the outer boundary detector 24 detect two reference points by using a infrared illumination from the eye image acquired by the iris recognition system, determine candidate edge points between the iris and the pupil of the iris image where a line crossing the two reference points intersects, determine the candidate edge points where a perpendicular line crossing the center point between the two candidate edge points intersects, determine the pupil location and the pupil size by obtaining the radius and the center point of the circle that are close to the candidate edge points based on the candidate center point where the perpendicular lines crossing the center point between the neighboring candidate edge points intersects, and to thereby detect the pupil region.

The shape descriptor detector 29 detects the shape descriptor which is invariant to motion, scale, illumination and rotation of the iris image. The Zernike moment is generated based on the feature extracted from the scale space and the scale illumination and the shape descriptor which is rotation-invariant and noise-resistant by using Zernike moment is extracted based on the Zernike moment. The indexed similar iris shape group database can be implemented based on the shape descriptor, and therefrom the indexed iris shape group having the iris shape descriptor similar with that of the query image can be searched.

The shape descriptor extractor 29 extracts the shape descriptor based on the linear shape descriptor extraction method. Thus, a skeleton is extracted from the iris image. A line list is obtained by connecting pixels based on the skeleton. The line list normalized is determined as the shape descriptor. The iris shape database indexed by a dissimilar shape descriptor can be implemented by measuring dissimilarity of the indexed similar iris shape group based on the linear shape descriptor and therefrom the iris image matched to the query image can be searched.

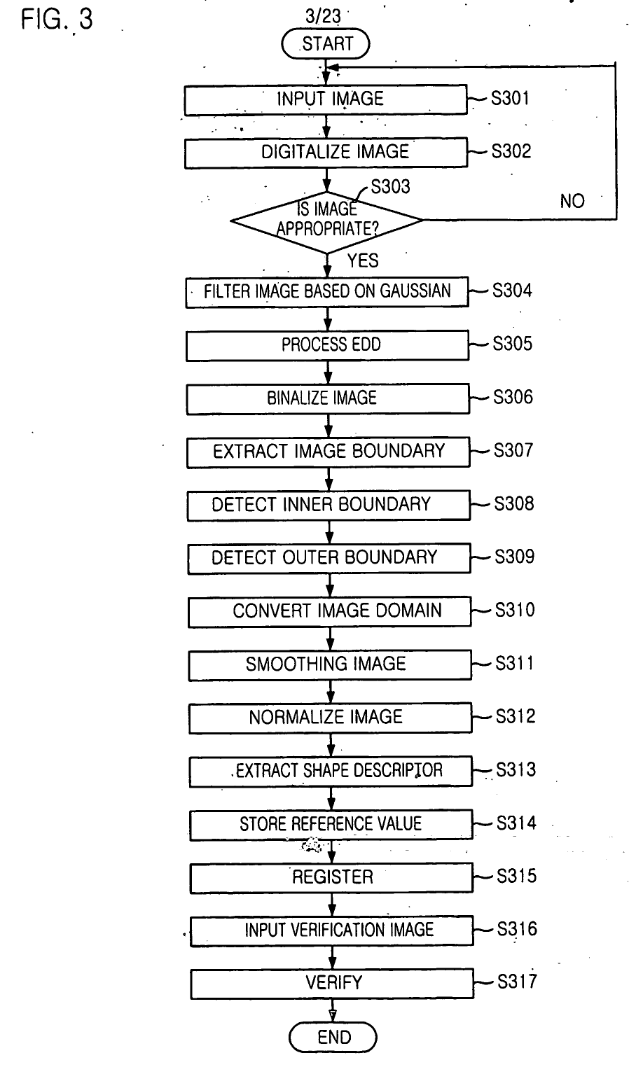

Features of the each element 21 to 31 of the iris recognition system will be described in detail hereinafter in conjunction with FIG. 3.

The iris image for the iris recognition rust include the pupil, the iris furrow outside of the pupil and the entire colored part of the eye. Because the iris furrows are used for the iris recognition, the color information does not need. Therefore, a monochrome image is obtained.

If the illumination is too strong, the illumination may stimulate the user's eye, result unclear features of the iris furrows and can not prevent reflected rays to occur. Under the consideration of the above conditions, the infrared LED is desirable.

A digital camera using a CCD or COMS chip that can achieve the image signal, display the image signal and capture the image. The image captured by the digital camera is preprocessed.

For simple description of the iris recognition phases, a at first, the iris area included the eye must to be captured. The resolution of the iris image is normally from 320×240 to 640×480. If there are a lot of noises in the image, an acceptable result can not be obtained even though preprocessing is excellently performed. Therefore, image capturing is important. It is important to maintain that conditions of neighboring environment are unchangeable with the time. It is indispensable to determine a location of the illumination so that an interference of the iris by the reflected light due to the illumination must be minimized.

Phases of, extracting the iris area and removing the noise from the image are called as preprocessing. The preprocessing is required for extracting accurate iris features and includes a scheme for detecting an edge between the pupil and the iris, dividing the iris area and converting the divided iris area into adaptable coordinates.

The preprocessing includes detail processing phases that evaluate a quality of the achieved image, selects the image and makes the image to be utilized. A process to analyze the preprocessed features and convert the feature into a code having certain information is a feature extraction phase. The code is to be compared or to be studied. At first, the scheme for selecting the image is described, and then the scheme for dividing the iris will be described.

The image capturing unit 21 achieves the image appropriate for the iris recognition by using digitalization, i.e., sampling and quantization, and suitability decision, i.e., eye blink detection, pupil location detection and vertical edge component distribution. The image capturing unit 21 performs to determine whether the image is appropriate for the iris recognition. The detail description will be described as follows.

First of all, a method for selecting an image to be used efficiently through a simple suitability decision phase among a plurality of captured images from a fixed focus camera as a method for achieving the image in the iris recognition system will be described.

For achieving the image by the digital camera using the CCD or CMOS chip, a plurality of the images are inputted and preprocessed in a determined time. A method for determining a moving image frame ranking through a real-time image suitability decision instead of recognizing all input images is used.

According to the above processes, the processing time is decreased and the recognition performance is increased. For selecting an appropriate image, pixel distribution and edge component ratio are used.

The digitalization at steps S301 and S302 of the 2-dimensional signals from the input image will be described.

The image data is expressed as an analog value of z-axis on the 2-dimensional space, i.e., x-y axis. For digitalizing the image, a space region is digitalized, and then a gray-level is digitalized. The digitalization of the space region is called as a horizontal digitalization, and the digitalization of the gray-level is called as a vertical digitalization.

The digitalization of the space region enlarges time axis sampling of a one-dimensional time series signal to a sampling of two-dimensional axis. In other words, the digitalization of the space region expresses the gray-level of discrete pixels. The digitalization of the space region determines the resolution of the image.

The quantization of the image, i.e., the digitalization of the gray-level is a phase for limiting the gray-level into the determined steps. For example, if the number of the steps for the gray-level is limited to 256, the gray-level can be expressed from 0 to 255. Thus, the gray-level is expressed in 8 bit binary number.

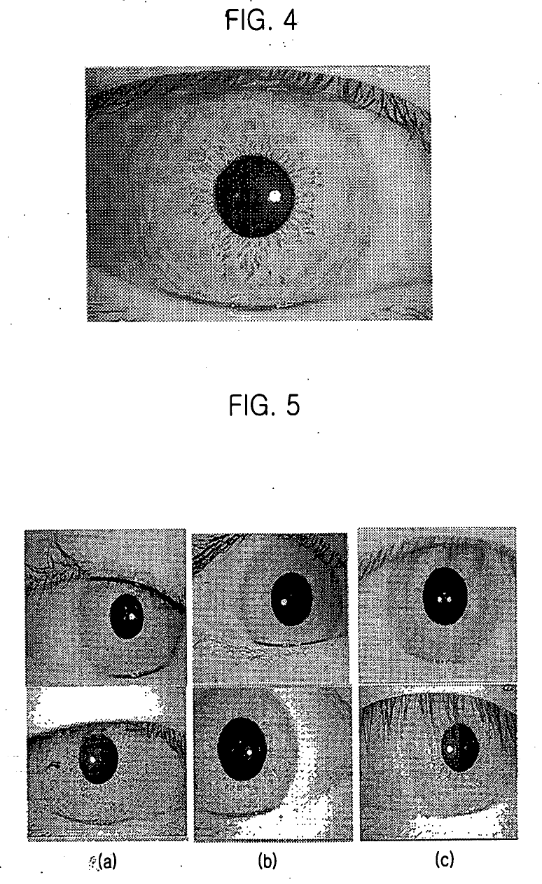

The image which is appropriate for the iris recognition shows features of the iris pattern clearly and includes the entire iris area in the eye image. The accurate decision for the quality of the achieved image is important factor to affect the iris recognition system performance. FIG. 4 is an example image of a qualified image for the iris recognition that the iris pattern is clear and there is no interference by the eyelid or the eyebrow.

Meanwhile, if all input image are automatically provided to the iris recognition system, a recognition failure occurs due to an imperfect image and a low-qualified image. There are four cases of failure eye image causing recognition fail.

The first case is that there is an eye blink as shown in FIG. 5 (a), the second case is that a part of the iris area is truncated because a center of the pupil is out of the center of the image due to a user's motion as shown in FIG. 5 (b) and the third case is that the iris area is interfered by the eyelash as shown in FIG. 5 (c). An additional case is that there are many noises in the eye image (not shown). Most of above cases fails to recognize the iris. Therefore, images of above cases are rejected by preprocessing, and to thereby improve efficiency of processing and a recognition rate.

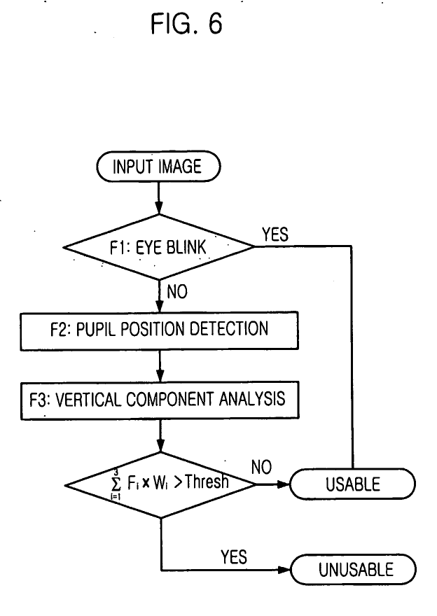

As mentioned above, the decision conditions for the qualified image can be provided with three functions as follows (See FIG. 6) at step S303.

1) Decision condition function F1: eye blink detection.

2) Decision condition function F2: location of a pupil.

3). Decision condition function F3: vertical edge component distribution.

The input image is subdivided into M×N blocks, which are utilized for functions of each step, and Table 1 as below shows an example of counting each block when the input image is subdivided into 3×3.

TABLE 1

| | | |
|---|---|---|
| B1 | B2 | B3 |
| B4 | B5 | B6 |
| B7 | B8 | B9 |

Because an eyelid area is brighter than a pupil area and an iris area generally, it is determined to the eye blink image when the image satisfies Eq. 1 as followings. Thus, it is determined that the image is unusable (i.e., the eye blink detection).

$$Max ( {\sum }_{i = 1}^{M \times \frac{N}{3}} {M}_{i} , {\sum }_{i = M \times \frac{N}{3} - 1}^{2 M \times \frac{N}{3}} {M}_{i} , {\sum }_{i = 2 M \times \frac{N}{3} - 1}^{3 M \times \frac{N}{3}} {M}_{i} ) = {\sum }_{i = 1}^{M \times \frac{N}{3}} {M}_{i} , \\ {M}_{i} = Mean ( {B}_{i} ) \qquad Eq . 1$$

The pupil is the region that has the lowest pixel values. The pupil region is located in as much as the center, the probability that the whole iris area is included in the image is increased (i.e., the pupil location detection). Therefore, as Eq. 2, the image is subdivided into M×N blocks, the block of which pixel average is the lowest is detected, and the weight is added according to the location of the block. The weight of the pixel is smaller and smaller apart from the center of the image.
Score(LoM(B), w)
LoM(B)=LoctionofMin(B_{i,.}, B_{M×N})
F2=w Eq. 2

There are many vertical edge components at the pupil boundary and the iris boundary in the iris image (i.e., the edge component ratio investigation). Based on a location of the pupil detected by Sobel edge detector as Eq. 1, the vertical edge components of the left and right region of the image are investigated and the component comparisons are performed in order to investigate that whether an accurate boundary detection is possible or not and the change of the iris pattern pixel value is not large due to a shadow in the iris area extracting process which is the next step of the image acquisition.

$$F 3 = \vert \frac{L ( Θ ) + R ( Θ )}{L ( Θ ) - R ( Θ )} \vert , Θ = \frac{{E}_{v}}{{E}_{v} + {E}_{h}} \qquad Eq . 3$$

Wherein, L is a left region of the pupil location, R is a right region of the pupil location, E, is a vertical component and Eₕ is a horizontal component.

The sum of each decision condition function value indicates utilization suitability of the image recognition process (Refer to Eq. 4), and is the base for counting frames of a moving picture achieved during a specific time (suitability investigation).

$$V = {\sum }_{i = 1}^{3} {F}_{i} \times {w}_{i} , V > T \qquad Eq . 4$$

Wherein, T is a threshold, and intensity of the suitability is controlled according to the threshold.

Meanwhile, the reference point detector 22 detects a real center point of the pupil after detecting a reference point of the pupil from the achieved image by Gaussian blurring at step S304 including blurring, edge soften and noise reduction, Edge Enhancing Diffusion (EED) at step S305, image binalization at step S306. Thus, the noise is removed by the EED method using a diffusion tensor, the iris image is diffused by Gaussian blurring, and, a real center of the pupil is extracted by Magnified Greatest Coefficient method. The diffusion is used for decreasing bits/pixel of the image in the binalization process. Also, the EED method is used for decreasing edges. Detail part of the image is removed by Gaussian blurring that is a low frequency pass filter. When the image is diffused, the actual center and size of the pupil are found by changing a threshold used for the binalization process. Detail description is as follows.

As the first preprocessing step, the edge is softened and noises in the image are removed by Gaussian blurring at step S304. However, too large Gaussian value cannot be used because dislocation occurs in the low-resolution image. If too large Gaussian deviation value is used, dislocation occurs in a low-resolution image. If there is mere noise in the image, Gaussian deviation value can be small or none.

Meanwhile, at step S305, the EED method is applied strongly to a part where the direction is the same with the edge, and is applied weakly to a part where the direction is an orthogonal to the edge by considering the local edge direction. Non-linear Anisotropic Diffusion Filtering (NADF) is one of the diffusion filtering methods and the EED method is a major method of the NADF.

In the EED method, the iris image after Gaussian blurring is diffused and a diffusion tensor matrix is used by considering not only a contrast of the image but the edge direction.

At the first phase for implementing the EED method, the diffusion tensor instead of a conventional scalar diffusivity is used.

The diffusion tensor matrix can be calculated based on eigenvectors v1 and v2. The v1 is paralleled with ∇u as Eq. 5 and the v2 is orthogonal to ∇u as Eq. 6.
v1||∇u Eq. 5
v2⊥∇u Eq. 6

Therefore, Eigenvalues λ1 and λ2 are selected in order to perform smoothing at the part paralleled with the edge rather than the part orthogonal to the edge. Eigenvalues are expressed as:
diffusion across edge λ1:=D(|∇u|\hat{2}) Eq 7
diffusion along edge λ2:=1 Eq. 8

According to the above method, the diffusion tensor matrix D is calculated based on an equation expressed as:

$$D = [ \begin{matrix}V 1 & V 2\end{matrix} ] [ \begin{matrix}D ( {\vert ∇ χσ \vert}^{2} & 0 \\ 0 & 1\end{matrix} ] [ \begin{matrix}v {1}^{′} \\ v {2}^{′}\end{matrix} ] \qquad Eq . 9$$

In order to implement the diffusion tensor matrix D in a real program, the v1 and v2 must be clearly defined. If the original iris image is expressed as Gaussian-filtered vector (gx, gy), the v1 makes the original iris image to be a parallel with Gaussian filtered image and can be expressed as (gx, gy) as shown in Eq. 5. The v2 is orthogonal to Gaussian-filtered image and the scalar product of (gx, gy) and the v2 is made to be zero as shown in Eq. 6. Therefore, the v2 is expressed as (-gx, gy). Because v1′ and v2′ are transpose matrix of the v1 and the v2 respectively, the diffusion tensor matrix D can be expressed as:

$$D = [ \begin{matrix}gx & - {gy}^{2} \\ gy & gx\end{matrix} ] [ \begin{matrix}d & 0 \\ 0 & 1\end{matrix} ] [ \begin{matrix}gx & gy \\ - gy & gx\end{matrix} ] \qquad Eq . 10$$

Wherein the d can be calculated based on diffusivity which is presented in Eq. 14 as follows.

At the second phase for implementing the EED method, a constant K is determined. The K denotes how much an absolute value is accumulated in a histogram of the absolute value. If the K is 90% or above, it can be a problem that detail structures of the iris image is quickly removed. If the K is 100%, it can be a problem that the whole iris image is blurred and the dislocation occurs. If the K is too small, the detail structures still remain after a lot of time iterations.

At the third phase for implementing the EED method, the diffusivity is evaluated. A gradient is calculated by Gaussian blurring the original iris image. A magnitude of the gradient is obtained. Because a gray-level is rapidly changed at the edge, a differential operation that takes the gradient is used for extracting the edge. The gradient at point (x, y) of the iris image f(x, y) is a vector expressed as Eq. 11. The gradient vector at point (x, y) denotes maximal change rate direction of the f.

$$∇ f = [ \begin{matrix}Gx \\ Gy\end{matrix} ] = [ \begin{matrix}\frac{\partial f}{\partial x} \\ \frac{\partial f}{\partial y}\end{matrix} ] \qquad Eq . 11$$

The gradient vector ∇f is expressed as:
∇f=mag(∇f)=[Gₓ²+G_{y}²]^{1/2} Eq.12

The ∇f is equal to a maximal increase rate per unit length at a direction of ∇f.

In practice, the gradient is approximated as shown in Eq. 13 expressed with absolute values of the gradient. Eq. 13 is easy to calculate and implement with a limited hardware.
∇f≈|Gₓ|+|G_{y}| Eq. 13

The diffusivity expressed as Eq. 14 is obtained based on the K and the obtained at the second phase.
D=1/(1+magnitude of gradient/Kˆ2) Eq. 14

At the forth phase for implementing the EED method, the diffusion tensor matrix D is obtained as shown in Eq. 10 and a diffusion equation is evaluated based on Eq. 15. At first, the gradient of the original iris image and then the gradient of the Gaussian-filtered iris image are applied to the original iris image. For the gradient of the Gaussian-filtered iris image does not exceed 1, the normalization must be performed.
αt u=d iv (D·∇u) Eq 15

The iris image is diffused under consideration of not the edge direction but contrast because the diffusion tensor matrix is used. The smoothing is weakly performed where orthogonal to the edge, and is strongly performed where paralleled with the edge. Therefore, a problem that the edge with the noise is extracted where there are a lot of noises in the edge can be improved.

A process from the second phase to the forth phase is repeated up to the maximal time iteration. Problems caused by many noises in the original iris image, scale-invariant image due to the constant K and unclear edge extraction due to noises at the edge are solved by processing the above four phases.

The ∇u as shown in Eqs. 5 to 15 denote the diffusion of each part of the image. The diffusion tensor matrix D is evaluated based on the eigenvector for the edge of the image and then the divergence is performed resulting linear integral, and thereby the contour of the image is obtained.

Meanwhile, the iris image is transformed into a binary image for obtaining a shape region of the iris image at step S306 (the image binalization). The binary image is black and white data of the monochrome iris image based on the threshold value.

For image subdivision, gray-level or chromaticity of the iris image is evaluated into the threshold value. For example, the iris area is darker than the retina area of the iris image.

Iterative thresholding is used for obtaining the threshold value when the image binalization is performed.

The iterative thresholding method is to improve an estimated threshold value by the iteration. It is assumed that the binary image obtained based on the first threshold is used for selecting the threshold resulting a better image. A process for changing the threshold value is very important to the iterative thresholding method.

At the first phase of the iterative thresholding method, an initial estimated threshold value T is determined. A mean brightness of the binary image can be a good threshold value.

At the second phase of the iterative thresholding method, the binary image is subdivided into a first region R1 and a second region R2 based on the initial estimated threshold value T.

At the third phase of the iterative thresholding method, average gray levels μl and μl of the first region R1 and the second region R2 are obtained.

At the forth phase of the iterative thresholding method, a new threshold value is determined based on Eq. 16 expressed as:
T=0.5(μ₁+μ₂) Eq. 16

At the fifth phase, a process from the second phase to the forth phase is iterated until the average gray levels μ1 and μ2 are not changed.

After the binalization of the whole image, data is obtained. The inner boundary-and the outer boundary are detected based on the data.

A process for detecting the inner boundary and the outer boundary is described as follows, i.e., a pupil detection that determines a center and a radius of the edge at steps S307 to S309.

The inner boundary detector 23 detects the inner boundary between the pupil and the iris at steps S307 and S308. The binary image binalized based on Robinson compass Mask is subdivided into the iris and the background, i.e., the pupil. And, intensity of the contour is detected based on Difference of Gaussian (DoG) so that only intensity of contour is appeared. Then, thinning is performed on the contour of the binary image using Zhang Suen algorithm. The center coordinate is obtained based on bisection algorithm. A distance from the center coordinate to a radius of the pupil in the counter clock-wise is obtained based on Magnified Greatest Coefficient method.

The Robinson compass Mask is used for detecting the contour. The Robinson compass Mask is a first-order differentiation and a form of 3×3 matrix that evaluates an 8-directional edge mask by rotating Sobel edge sensitive a diagonal directed contour to the left.

Also, the DoG that is a quadratic differentiation is used for extracting the detected contour. The DoG decreases noises in the image based on Gaussian smoothing function, decreases a lot of the operations due to a mask size by decreasing two Gaussian mask, i.e., LoG, and is a high frequency pass filtering operation. The high frequency denotes that a brightness distribution difference with the background is large. Based on the above operations, the contour is detected.

Also, the thinning transforms the contour into a line of one pixel and obtains the center coordinate using the bisection algorithm, and to thereby obtain the radius of the pupil based on Magnified Greatest Coefficient method. The contour is formed to a circle and then, the center point is applied to the circle, and thereby the most similar shape to the pupil is selected.

The outer boundary detector 24 detects the outer boundary between the iris and the sclera at steps S307 to S309.

For the outer boundary detection, the center point is obtained based on the bisection algorithm. A distance from the center point to a radius of the pupil is obtained based on Magnified Greatest Coefficient method. Wherein, the linear interpolation is used to prevent that the image is distorted when coordinates system is transformed from Cartesian coordinates system to the polar coordinates system.

Edge extraction of the image, i.e., thinning and labeling, is needed at step S307 for the inner boundary and the outer boundary detections at steps S308 and S309. The edge extraction of the image means a process that the binary image is subdivided into the iris and the background based on the Robinson compass Mask, the intensity of the contour is enhanced based on the DoG, and the thinning is performed on the contour based on the Zhang Suen algorithm.

Referring to the edge extraction at step S307, because the edge is where the density is rapidly changed, the differentiation analyzing the value of the function change is used to extracting the contour. There are a first differentiation, i.e., the gradient and a quadric differentiation, i.e., the laplacian in the differentiation. Also, there is the edge extracting method by using a template-matching.

The gradient observes a brightness change of the iris and is a vector G(x, y)=(fx, fy) expressed as:
G(x)=f(x+1)−f(x),G(y)=f(y+1)−f(y) Eq. 17

Wherein, the fx is a gradient of x direction and the fy is a gradient of y direction.

The Robinson compass Mask gradient operator 3×3 is illustrated in below and is the 8-directional edge mask made by rotating the Sobel mask to the left. The direction and the magnitude are determined according to the direction and the magnitude of the mask having the maximum edge value.

| | | |
|---|---|---|
| −1 | 0 | 1 |
| −2 | 0 | 2 |
| −1 | 0 | 1 |

The contour of the image must be pre-extracted to preprocess the acquired image. The iris and the background are subdivided based on the Robinson compass Mask that is the gradient. The gradient at the point (x, y) of the image f(x, y) is expressed as Eq. 18. A magnitude of the gradient vector (∇f) is expressed as Eq. 19. The gradient based on the Robinson compass Mask is given from the maximum edge mask among the following 8-directional masks based on Eq. 20. The z is brightness of pixel overlapped by the mask at a location. The edge direction is a direction where the edge is put and can be derived from a result of the gradient. The edge direction is orthogonal to the gradient direction. That is, the gradient direction denotes by a direction where difference value is changed largely and the edge must exist where the valued is changed largely. Therefore the edge is orthogonal to the gradient direction.

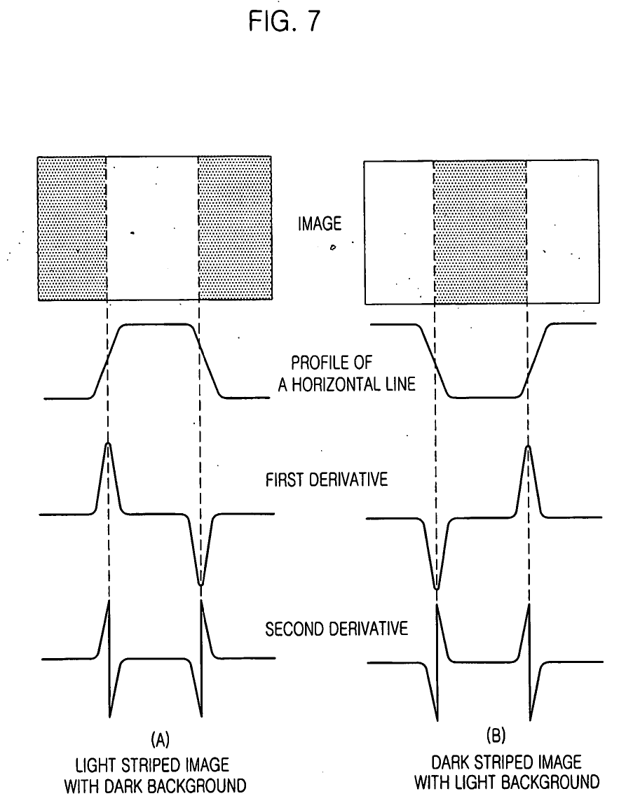

FIG. 7 (b) is an image having the extracted contour.

$$\begin{matrix}∇ F = [ \begin{matrix}{G}_{x} \\ {G}_{y}\end{matrix} ] = [ \frac{\frac{\partial f}{\partial x}}{\frac{\partial f}{\partial y}} ] & Eq . 18 \\ \begin{matrix}∇ f = mag ( ∇ F ) = {[ {G}_{z}^{2} + {G}_{y}^{2} ]}^{1 / 2} \\ ∇ f \approx \vert {G}_{x} \vert + \vert {G}_{y} \vert\end{matrix} & Eq . 19 \\ \begin{matrix}{G}_{x} = ( {Z}_{7} + {Z}_{8} + {Z}_{9} ) - ( {Z}_{1} + 2 {Z}_{2} + {Z}_{3} ) \\ {G}_{y} = ( {Z}_{3} + {Z}_{6} + {Z}_{9} ) - ( {Z}_{1} + 2 {Z}_{4} + {Z}_{7} )\end{matrix} & Eq . 20\end{matrix}$$

The subscripts denote pixels as shown in Eq. 20.

Meanwhile, the laplacian observes the brightness distribution difference with neighboring area. The laplacian performs the differentiation on the result of the gradient, and to thereby detect the intensity of the contour. That is, only magnitude of the edge but not the direction is obtained. The laplacian operator targets to find zero-crossings where the value is changed from + to − or from − to +. The laplacian decreases the noise in the image based on the Gaussian smoothing function and uses the DoG operator mask that decreases many operations due to the mask magnitude by subtracting the Gaussian masks having different values. Because the DoG approximates the LoG, a desirable approximation is obtained when a ratio σ1/σ2 is 1.6.

The LoG and the DoG of two-dimensional function f(x, y) are expressed as:

$$\begin{matrix}LoG ( x , y ) = \frac{1}{{πσ}^{4}} [ 1 - \frac{{x}^{2} + {y}^{2}}{2 {σ}^{2}} ] {ⅇ}^{\frac{- ( {x}^{2} + {y}^{2} )}{2 {σ}^{2}}} & Eq . 21 \\ DoG ( x , y ) = \frac{{ⅇ}^{\frac{- ( {x}^{2} + {y}^{2} )}{2 {σ}_{1}^{2}}}}{2 {πσ}_{1}^{2}} - \frac{{ⅇ}^{\frac{- ( {x}^{2} + {y}^{2} )}{2 {σ}_{2}^{2}}}}{2 {πσ}_{2}^{2}} & Eq . 22\end{matrix}$$

The edge detection using the laplacian operator uses the 8-directional laplacian mask as shown in Eq. 23 and 8 direction values based on the center, and to thereby determine, a current pixel value.
Laplacian(x,y)=8×Γ(x,y)−(Γ(x,y−1)+Γ(x,y+1)+Γ(x−1, y)+Γ(x+1, y)+Γ(x+1, y+1)+Γ(x−1, y−1)+Γ(x−1, y+1)+Γ(x+1,y−1)) Eq. 23

The laplacian quadric differentiation operator 3×3 is as followings.

Laplacian mask: direction-invariant

| X direction | | | Y direction | | |
|---|---|---|---|---|---|
| −1 | −1 | −1 | 0 | −1 | 0 |
| −1 | 8 | −1 | −1 | 4 | −1 |
| −1 | −1 | −1 | 0 | −1 | 0 |

The thinning is described hereinafter.

The Zhang Suen thinning algorithm is one of parallel processing-methods, wherein deletion means that a pixel is deleted for the thinning. Therefore, the black is converted into the white.

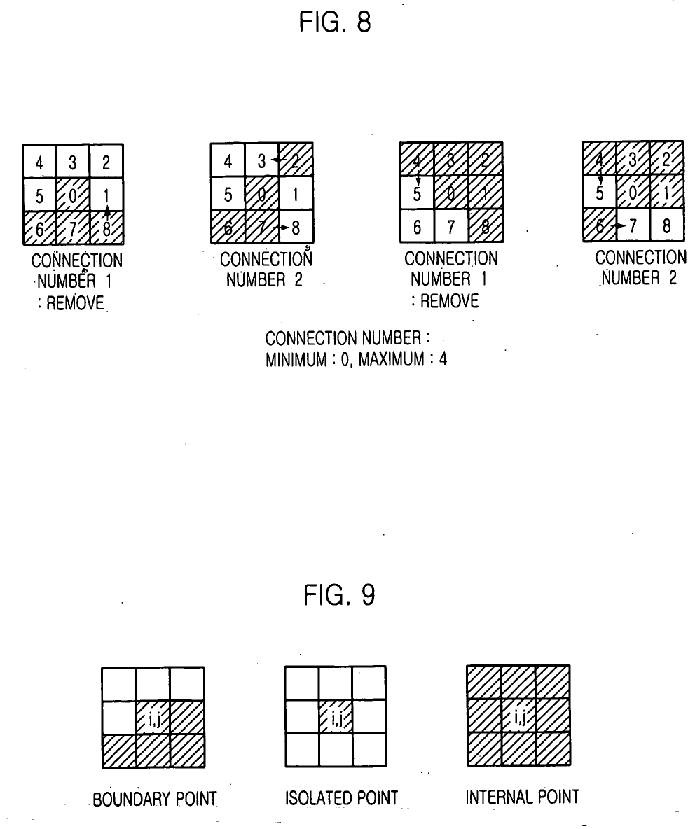

Connection number is a number indicating whether a pixel is connected to neighboring pixels or not. That is, if the connection number is 1, the center pixel, i.e., 0, can be deleted. A convergence from black to white or from white to black is monitored. FIG. 8 shows a check all pixels are converted from the back to the white. The pixel must be 1 regardless neighboring pixel numbers.

Meanwhile, a labeling means distinguishing iris sessions apart from each other. A set of neighboring pixels is called as a connected component in a pixel array. One of most frequently used operations in a computer vision is to search the connected component from the given image. Pixels belongs to the connected component have high probability to indicate an object. A process for giving the label, i.e., the number, to the pixels according to the connected component where the pixels belongs is called as the labeling. An algorithm for searching all connected components, giving the same-label to pixels included in an identical connected component is called as a component labeling algorithm. The sequential algorithm takes short time and small memory comparing to an iteration (algorithm, and completes calculations within two times scanning to the given image.

The labeling can be completed with two loops using an equivalent table. The drawback is that the labeling numbers are not continuous. The entire iris sessions are checked and labeled. During the labeling, if other label is detected, the label is inputted in the equivalent table. The labeling is performed with the minimum label in a new loop.

At first, a black pixel on the boundary is searched as shown in FIG. 9. The boundary point has 1-7 white pixels in the neighbor based on a center pixel. An isolate point is excluded. The isolated point's all neighboring pixels are black. Then, the labeling is performed in a horizontal direction and then a vertical direction. With two directional labeling as above, a U shape curve can be labeled in onetime, and thereby the time is saved.

The center point of the boundary and the radius determination, i.e., the pupil detection, steps for the pupil detection at the inner boundary detector 23 and the outer boundary detector 24 will be described.

As above mentioned, in the pupil detection process, two reference points of the pupil from the light source of the infrared illumination are detected at S1. The candidate boundary points are determined at S2. The pupil region is detected in real-time by obtaining the radius and the center point which are the closet to the candidate boundary point based on the candidate center point and determining the pupil location and the pupil size at S.

The process for detecting two reference points in the pupil from the light source of the infrared illumination will be described.

For detecting the pupil location, the present invention obtains a geometrical variation of the light component generated in the eye image, calculates an average of the geometrical variation and uses the average as a template by modeling the average into the Gaussian waveform as Eq. 24.

$$G ( x , y ) = exp ( - 0.5 ( \frac{{x}^{2}}{{σ}^{2}} + \frac{{y}^{2}}{{σ}^{2}} ) ) \vert \qquad Eq . 24$$

Wherein, x is a horizontal location, y is a vertical location and σ is a filter size.

The two reference points are detected by performing a template matching based on the template so that the reference point is selected in the pupil of the eye image.

Because the illumination in the pupil of the eye image is the only part where a radical change of the gray-level occurs, it is possible to extract the reference point stably.

The process for determining the candidate pupil boundary point at S2 is described hereinafter.

At the first step, a profile is extracted presenting the pixel value change of the waveform in +/−x axes based on the two reference points. The candidate boundary masks h(1) and h(2) corresponding to the gradient are generated in order to detect two candidate boundaries passing the two reference points in form of one-dimensional signal in the x direction. Then, the candidate boundary point is determined by generating a candidate boundary waveform (Xn) using a convolution of the profile and the candidate boundary mask.

At the second step, another candidate boundary point is determined by the same method of the first step on a perpendicular line based on the center point bisecting a distance between the two candidate boundary points.

Meanwhile, the process for detecting the pupil region in real time by obtaining the radius and the center point of a circle which are the closet to the candidate boundary point based on the candidate center point and determining the pupil location and the pupil size at S3 will be described hereinafter.

The radius and the center point of the circle closet to the candidate boundary point is obtained by using the candidate center point where the perpendicular lines at the bisecting points between the neighboring candidate boundary points are intersected. Hough transform for obtaining a circle component shape is applied to the above method.

It is assume that there are two points A and B on a circle and a point C is a bisecting point of a line AB connecting points A and B. A line that crosses the point C and is perpendicular to the line AB always passes an origin O of the circle. An equation of a line OC is expressed as:

$$y = - \frac{{x}_{A } - {x}_{B}}{{y}_{A} - {y}_{B}} x + \frac{{x}_{A}^{2} + {y}_{A}^{2} - {x}_{B}^{2} - {y}_{B}^{2}}{2 ( {y}_{A} - {y}_{B} )} \qquad Eq . 25$$

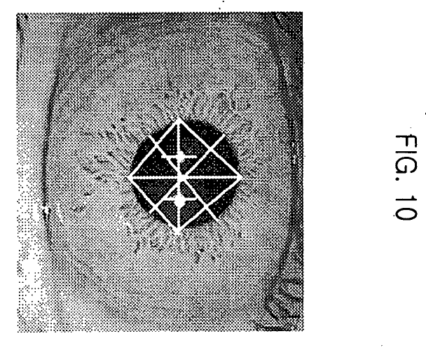

In order to obtain the features and the location of the connected components group that make the circle, the center point is used as an attribute of the connected components group. Because the center of the inner boundary of the iris is changed and the boundary is interfered by the noise, a conventional method for obtaining a circle projection may evaluate an inaccurate pupil center. However, because the method uses the two light sources that are apart from a specific distance, the candidate center distribution coefficient of the bisecting perpendicular lines is appropriate to determine the center of the circle. Therefore, a point where the perpendicular lines are mostly crossed among the candidate center points is determined as the center of the circle (See FIG. 10).

After extracting the center of the circle according to the above method, the radius of the pupil is determined. One, of the radius decision methods is an average method. The average method is to obtain an average distance of all distance of the group components making the circle from the determined center point. That is similar with Daugmans' method and Groen's method. If there are many noises in the image, the circumference component is distortedly recognized and the distortion affects to the pupil radius.

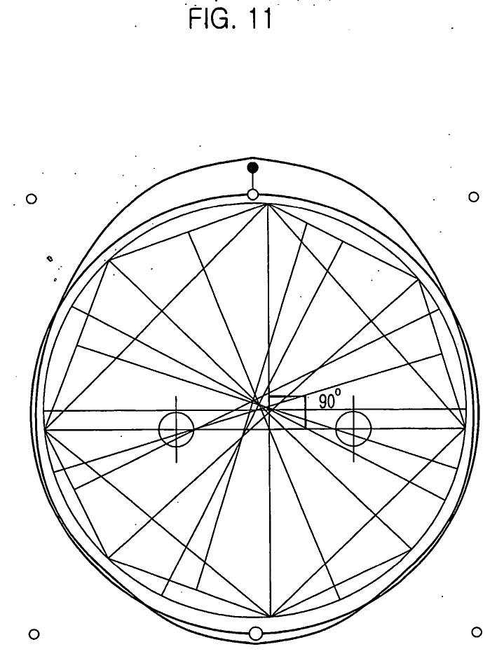

With comparison to the above method, Magnified Greatest Coefficient method is based on the enlargement from a small region to a large region. At the first step, a longer distance is selected among pixel distances between the center point and the candidate boundary points. At the second step, the range becomes narrower by applying the first step at the candidate boundary points over the selected distance. Therefore, the radius representing the circle is obtained by searching an integer finally. Because the distribution of transformation in all directions due to a contraction, expansion and a horizontal rotation of an iris muscle must be considered when the above method is used, it can extract the inner boundary of a stable and identical iris region (See FIG. 11.)
r²=(x−xₒ)²+(y−yₒ)² Eq. 26

Coordinates of the y is determined based on the radius and Eq. 26. If there is the black pixel in the image, the center point is accumulated. The circle is found based on the center point and the radius by searching the maximum accumulated center point. (Magnified Greatest Coefficient method)

The center point is obtained using a bisection algorithm. Because the pupil has different curvature according to the kind, the radius is obtained based on the Magnified Greatest Coefficient method in order to measure the curvature of the pupil. Then, a distance from the center point to the outline in the counter clock-wise is obtained. It is presented on a graph that an x-axis is a rotation angle and a y-axis is a distance from the center to the contour. In order to find the features of the image, a peak and a valley of the curvature are obtained and the maximum length and an average length between the curvatures are evaluated.

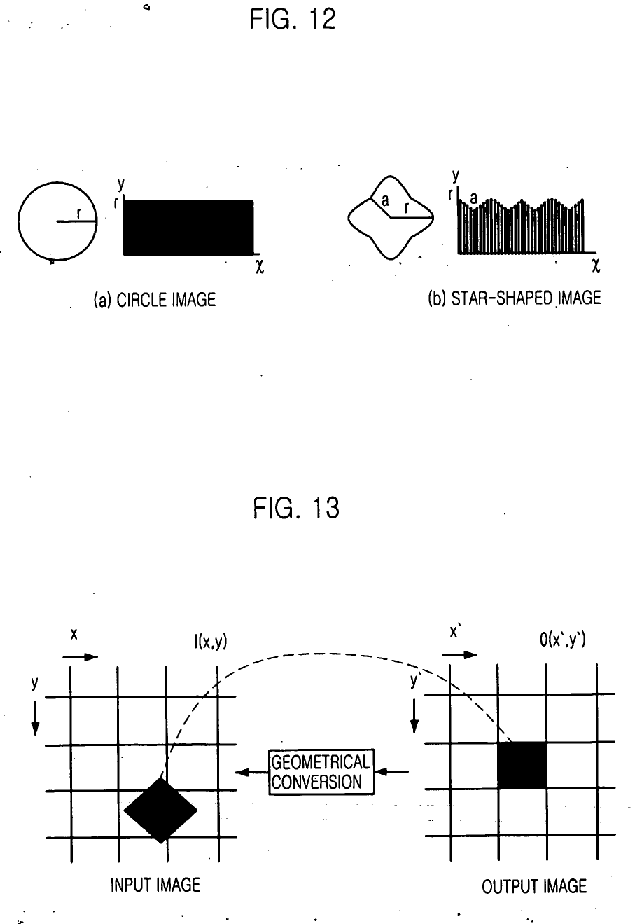

FIG. 12 is a graph showing the curvature graph of the acquired circle image (a) and the acquired star-shaped image (b). In the case of the circle image (a), because the distance from the center to the contour is uniform, the y has fixed value and the peak and the valley are r. The above case is weak for drape property. If the image is drifted, the distance from the center to the contour is changed. Therefore, the y is changed and has the curvature in the graph. In the case of the star-shaped image (b), there are four curvatures in the graph, and the peak becomes r and the valley becomes a.

Circularity shows how much the image looks like a circle. If the circularity is close to 1, the drape property is weak. If the circularity is close to 0, the drape property is strong. For evaluating the circularity, a circumference and an area of the image are needed. The circumference of the image is a sum of distances between pixels on the outer boundary of the image. If the pixel of the outer boundary is connected perpendicularly or in parallel, the distance between pixels is 1 unit. If the pixel is connected in diagonal, the distance between pixels is 1.414 units. The area of the image is measured as a total number of the pixels inside of the outer boundary. A formula for obtaining the circularity is expressed as:

$$circularity ( e ) = \frac{4 π \times area}{{( circumference )}^{2}} \qquad Eq . 27$$

According to the edge extraction process at step S307, the inner boundary is confirmed, and the actual pupil center is obtained using the bisection algorithm. Then, the radius is obtained using the Magnified. Greatest Coefficient method when the pupil is assumed to be a perfect circle, and the distance from the center to the inner boundary in the counter clock-wise is measured, and thereby the data is generated as shown in FIG. 12 (the inner boundary detector 23 and the outer boundary detector 24 perform.)

The processes from the binalization at step S306 to the inner boundary extraction at step S308 are summarized in sequence as follows: EED-> binalization of-> edge extraction-> bisection algorithm-> Magnified Greatest Coefficient method-> inner boundary data generation-> image coordinates system transformation.

Meanwhile, in the outer boundary detection at step S309, the edge between the pupil and the iris is found with the same method of the inner boundary detection filtering, i.e., the Robinson compass mask, the DoG and the Zhang Suen. Wherein, where the difference between the pixels is a maximum is determined as the outer boundary. The linear interpolation is used in order to prevent that the image is distorted due to motion, rotation, enlarge and reduction and in order to make the outer boundary as the circle after thinning.

The bisection algorithm and the Magnified Greatest Coefficient algorithm are used in the outer boundary detection at step S309. Because the gray-level difference of the outer boundary is not clearer than that of the inner boundary, the linear interpolation is used.

The process of the outer boundary detection at step S309 is described hereinafter.

Because the iris boundary is blurred and thick, it is hard to find the boundary exactly. The edge detector defines where the brightness is changed most as the iris boundary. The center of the iris can be searched based on the pupil center, and the iris radius can be searched based on that thee iris radius is mostly uniformed in the fixed focus camera.

The edge between the pupil and the iris is obtained with the same method of the inner boundary detection filtering, and where the pixel difference is a maximum is detected as the outer boundary by checking the pixel difference.

Wherein, the transformation, i.e., motion, rotation, enlargement and reduction, using the liner interpolation is used (See FIG. 13.)

As shown in FIG. 13, because a pixel coordinates is not matched 1 to 1 if the image is transformed, the inverse transformation complements the above problem. Wherein, if there is a pixel that is not matched in the image, the pixel is shown based on the pixel of the original image.

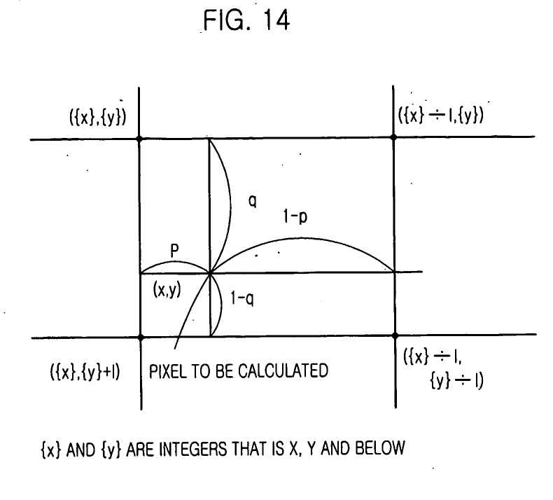

The linear interpolation as shown in FIG. 14 determines a pixel based on four pixels based on how close x, y coordinates are.

It is expressed using p and q as:
p(q*equation+(1−q)*equation)+q(p*equation+(1−p)*equation).

The image distortion is prevented by using the linear interpolation.

The transformation is subdivided into three cases, i.e., motion, enlargement & reduction and rotation.

The motion is easy to transform. A regular motion is to subtract a constant and n inverse motion is to plus the constant expressed as:
X′→x−a, Y′→y−b Eq. 28

The enlargement is to divide by the constant as Eq. 29 below. Therefore, x and y are enlarged. Also, the reduction is to multiply the constant.
Y′→t/a, X′→x/z Eq. 29

The rotation is to use a rotation transformation having a sine function and a cosine function expressed as:

$$\vert \begin{matrix}Sin θ & Cos θ & 0 \\ Cos θ & - Sin θ & 0 \\ 0 & 0 & 1\end{matrix} \vert \qquad Eq . 30$$

By unfolding Eq. 30, the inverse transformation equations are derived expressed as:
x=X′Cosθ−Y′Sinθ
y=X′Sinθ+Y′Cosθ Eq. 31

The processes from the binalization at step S306 to the outer boundary extraction at step S309 are summarized as follows: EED-> iris inner/outer binalization-> edge extraction-> bisection algorithm-> Magnified Greatest Coefficient method-> iris center search-> iris radius search-> outer boundary data generation-> image coordinates system transformation.

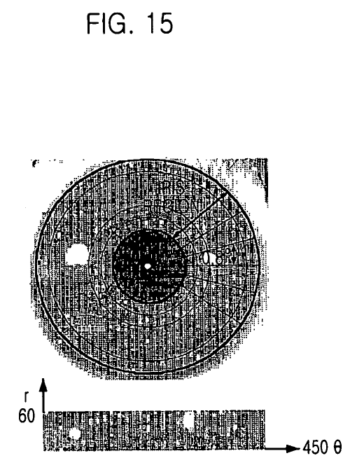

The process for transforming the Cartesian coordinates system into the polar coordinates system at step S310 will be described. As shown in FIG. 15, the divided iris pattern image is transformed from the Cartesian coordinates system into the polar coordinates system. The divided iris pattern means a donut-shaped iris.

The iris muscle and the iris layers reflect a defect of the structure and the connection state. Because the structure affects to a function and reflects the integrity, the structure indicates the resistance of the organic and the genetic stamp. The related signs are Lacunae, Crypts, Defect signs and Rarifition.

In order to use the iris pattern based on the clinical experience of the iridology as the features, the image analysis region defining unit 26 divides the iris analysis region as follows. Thus, it is subdivided into 13 sectors based on the clinical experience of the iridology.

Therefore, the region is subdivided into a sector 1 at right and left 6 degree based on the 12 clock direction, a sector 2 at 24 degrees, in the clock-wise, a sector 3 at 42 degree, a sector 4 at 9 degree, a sector 5 at 30 degree, a sector 6 at 42 degree, a sector 7 at 27 degree, a sector 8 at 36 degree, a sector 9 at 18 degree, a sector 10 at 39 degree, a sector 11 at 27 degree, a sector 12 at 24 degree and a sector 13 at 36 degree. Then, the 13 sectors are subdivided into 4 circular regions based on the iris. Therefore, each circular region is called as a sector 1-4, a sector 1-3, a sector 1-2, a sector 1-1, and so on.

Wherein, 1 sector means 1byte and stores iris region comparison data in a parted region, and to thereby be used for determining the similarity and the stability.

The two-dimensional coordinates system is described as follows.

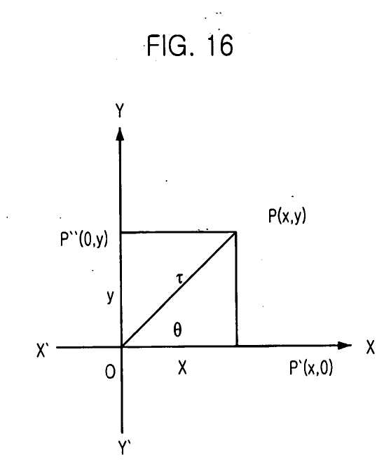

The Cartesian coordinates system is a typical coordinates system showing 1 point on a plane as shown in FIG. 16. A point O is determined as origin on the plane, and two perpendicular lines XX″ and YY′ crossing origin are axes. A point P on the plane is presented with a segment OP′=x passing the point P and parallel with x-axis and with a segment OP″=y passes passing the point P and parallel with y-axis. Therefore, the location of the point P is matched to an ordered pair of two real numbers (x, y), and reversely the location of the point P can be determined from the ordered pair (x, y).

Plane polar coordinates system is a coordinates system presented with a length of a segment connecting a point on the plane and the origin and an angle of the segment and an axis passing the origin. A polar angle Θ has a plus value in the counter clock-wise of the mathematical coordinates system, but the polar angle Θ has a plus value in the clock-wise of the general measurement such as the azimuth angle.

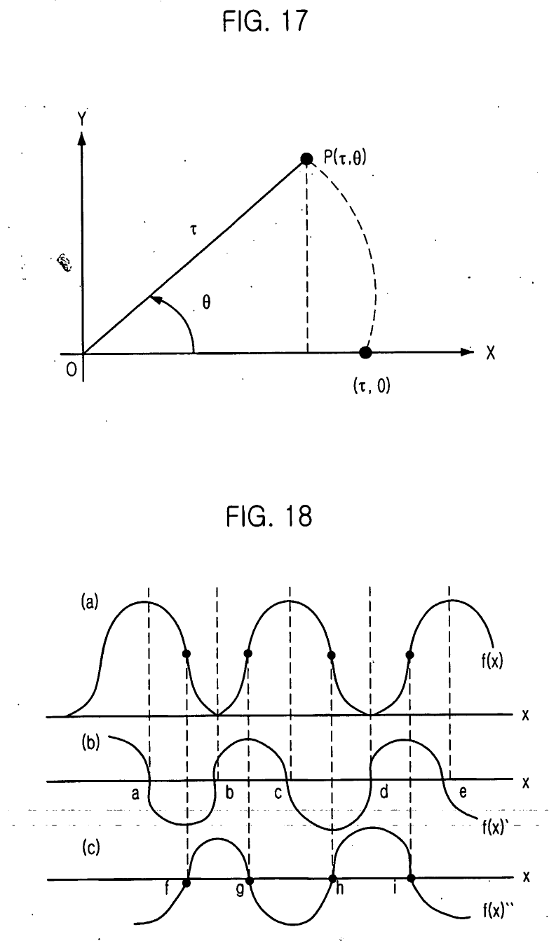

Referring to FIG. 17, the Θ is a polar angle, the O is a pole, and the OX is a polar axis.

A relation of the Cartesian coordinates system (x, y) and the Plane Polar Coordinates system (r, Θ) is expressed as:
r=Γx²+y²,Θ=tan⁻¹(y/x)
x=r cosΘ, y=r sinΘ Eq. 32

The image smoothing at step S311 and the image normalization at step S312 will be described.

The image normalizing unit 28 normalizes the image by a mean size based on a low-order moment at step S312. Before the normalization, the image smoothing unit 27 performs the smoothing on the image by using Scale-space filtering at step S311. When a gray-level distribution of the image is weak, it is improved by performing a histogram smoothing. Therefore, the image smoothing is used for distinguishing clearly the gray-level distribution difference among neighboring pixels. The scale-space filtering is performed in the image smoothing process. The Scale-space filtering is a form that Gaussian function and the scale constant is combined, and is used for making a size-invariant Zernike moment after the normalization.

The normalization at step S312 and then the image smoothing at step S311 will be described.

The normalization at step S312 must be performed before a post processing is performed. The normalization uniforms the size of the image, defines locations and adjusts a thickness of the line, and to thereby standardize the iris image.

The iris image can be characterized based on topological features. The topological feature is defined as invariant features in spite of elastic deformations of the image. Topological invariance excludes connecting other regions or dividing other regions. For a binary region, Topological characteristic features include the number of the hole and embayment, protrusion.

More precise expression than the hole is a subregion which exists inside of the iris analysis region. The subregion can appear recursively. The iris analysis region can include the subregion including another subregion. A simple example for explaining a discrimination ability of Topology is an alphanumeric. Symbols 0 and 4 have one subregion and B and 8 have two subregions.

Evaluation of the moments indicates a systemic method of the image analysis. The most frequently used iris features are calculated based on three moments from the lowest order. Therefore, the area is given by 0-order moment and indicates the total number of the region-inside. A centroid determined based on 1-order moments provides the measurement of the shape location. A directional motion of the regions is determined based on principal axes determined by order moments.

Information of the low-order moments allows evaluating central moments, normalized central moments and moment invariants. These quantities delivery shape features that are invariant to the location, the size, and the rotation. Therefore, when the location, the size and the directional motion does not affect to the shape identity, it is useful for shape recognition and the matching.

The moment analysis is based on the pixels inside of the iris shape region. Therefore; a growing or a filling of the iris shape region for summing all pixels inside of the iris shape region are needed in advance. The moment analysis is based on the contour of the bounding region of the iris shape image, and it requires the contour detection.

The pixels of the -bounding region are allocated as 1 (ON) for the binary image of the iris analysis region, and a moment m_{pq} of the binary image is defined as Eq. 33 below: Region-Based Moments. (p+q)^{th}-order normalized moments for 2-order iris analysis region shape f(x, y) are expressed as Eq. 33 below. Wherein, when p=0 and q=0, 0-order normalized moment is defined as Eq. 34 below and indicates a pixel number included in the iris analysis region shape. Therefore, the measurement of the area is provided. Generally, the number of the shape indicates a size of the shape but is affected by the threshold value in the binalization. Even though the size of the shape is same, the contour of the iris image resulted by the binalization based on a low value is thick and the contour of the iris image resulted by the binalization based on a high value is thin. Therefore, the pixel number varies in large at the 0-order moment value.

$$\begin{matrix}{m}_{pq} = {\sum }_{x = 0}^{N} {\sum }_{y = 0}^{M} f ( x , y ) {x}^{p} {y}^{q} & Eq . 33 \\ {m}_{pq} = {\sum }_{x = 0}^{N} {\sum }_{y = 0}^{M} f ( x , y ) & Eq . 34\end{matrix}$$

TABLE 2
[Moments and Vertex Coordinates]
$\begin{matrix}{m}_{00} = \frac{1}{2} {\sum }_{k = 1}^{N} {y}_{k} {x}_{k - 1} - {x}_{k} {y}_{k - 1} , \\ \begin{matrix}{m}_{10} = \frac{1}{2} {\sum }_{k = 1}^{N} \{ \frac{1}{2} ( {x}_{k} + {x}_{k - 1} ) ( {y}_{k} {x}_{k - 1} - {x}_{k} {y}_{k - 1} ) - \\ \frac{1}{6} ( {y}_{k} - {y}_{k - 1} ) ( {x}_{k}^{2} + {x}_{k} {x}_{k - 1} + {y}_{k - 1}^{2} ) \}\end{matrix} , \\ {m}_{11} = \frac{1}{3} {\sum }_{k = 1}^{N} \frac{1}{4} ( {y}_{k - 1} - {x}_{k} {y}_{k - 1} ) ( 2 {x}_{k} {y}_{k} - {x}_{k - 1} {y}_{k} + {x}_{k} {y}_{k - 1} + 2 {x}_{k - 1} {y}_{k - 1} ) , \\ \begin{matrix}{m}_{20} = \frac{1}{3} {\sum }_{k = 1}^{N} \{ \frac{1}{2} ( {y}_{k} {x}_{k - 1} - {x}_{k} {y}_{k - 1} ) ( {x}_{k}^{2} + {x}_{k} {x}_{k - 1} + {x}_{k - 1}^{2} ) - \\ \frac{1}{4} ( {y}_{k} - {y}_{k - 1} ) ( {x}_{k}^{3} + {x}_{k}^{2} {x}_{k - 1} + {x}_{k} {x}_{k - 1}^{2} + {x}_{k - 1}^{3} ) \}\end{matrix}\end{matrix}$

Generally, the moment mᵢⱼ is defined based on the pixel location and the pixel value expressed as:
m_{pg}=∫^{∞}_{-∞∫}^{∞}_{-∞x}^{p}y^{q}f(x,y)dxdy Eq. 35

Moment equations up to the quadratic-order are easily derived based on a static point defining the bounding region contour of the binary iris shape simply connected. Therefore, if it is possible to express a polygonal of a region contour, the area centroid and the directional motion of the principal axes can be easily derived based on the equation in Table. 2.

The lowest-order moment m₀₀ indicates the total pixel number inside of the iris analysis region shape and provides the measurement of the area. If the iris shape in the iris analysis region is particularly larger or smaller than another shape in the iris image, the lowest-order moment m₀₀ is useful as the shape descriptor. However, because the area occupies smaller part or larger part of the shape according to the scale of the image, a distance between the object and the observer and a perspective, it can not be used imprudently.

The 1-order moment of the x and the y normalized based on the area of the iris image provides coordinates of the x and y centroid. The average location of the iris shape region is determined based on the coordinates of the x and y centroid.

After the iris shape division process, all shapes of the image are given the same label and then the up and down boundaries of the iris are denoted by A and B, the left and right boundaries of the iris are denoted by L and R respectively, and the coordinates of the x and y centroid are expressed as:

$${X}_{o} = \frac{{m}_{10}}{{m}_{00}} = \frac{\sum \sum xf ( x , y )}{{\sum }_{x = A}^{B} {\sum }_{y = L}^{R} f ( x , y )} \\ {Y}_{c} = \frac{{m}_{01}}{{m}_{00}} = \frac{\sum \sum yf ( x , y )}{{\sum }_{x = A}^{B} {\sum }_{y = L}^{R} f ( x , y )} \qquad Eq . 36$$

The central moment μ_{pq} indicates iris shape region descriptor normalized based on the location.

$${μ}_{pq} = {\sum }_{R} {( x - {x}_{c} )}^{p} {( y - {y}_{c} )}^{q} \qquad Eq . 37$$

Generally, central moment is normalized with 0-order moment as Eq. 38 in order to evaluate the normalized central moment.
η_{pq}=μ_{pq}/μ₀₀^{γ}, γ=(p+q)/2+1 Eq. 38

The normalized central moment which is the most frequently used is a μ₁₁ that is a 1-order central moment between x and y. The μ₁₁ provides the measurement of the variation from the circle regions shape. Therefore, a value close to 0 describes a region similar to the circle and a large value describes a region dissimilar to the circle. A principal major axis is defined as an axis passing the centroid having the maximum inertia moment and a principal minor axis is defined as an axis passing the minimum centroid. Directions of the principal major and minor axes are given as:

$$\begin{matrix}tan θ = \frac{1}{2} ( \frac{{μ}_{02} - {μ}_{20}}{{μ}_{11}} ) \pm \frac{1}{2 {μ}_{11}} \\ \sqrt{{μ}_{02}^{2} - 2 {μ}_{02} {μ}_{20} + {μ}_{20}^{2} + 4 {μ}_{11}^{2}}\end{matrix} \qquad Eq . 39$$

Estimation of the direction provides an independent method for determining an orientation of an almost circle shape. Therefore, it is an appropriate parameter to monitor the orientation motion of the transformed contour, e.g., for time-variant shapes.

The normalized and central normalized moments are normalized based on the scale (area) and the motion (location). The normalization based on the orientation is provided by a family of the moment invariants. Table 3 evaluated based on the normalized central moments shows four moment invariants from the first.

TABLE 3
Central moments

| | |
|---|---|
| μ₁₀ = μ₀₁ = 0, | μ₁₁ = m₁₁ − m₁₀m₀₁/m₀₀, |
| μ₂₀ = m₂₀ − m₁₀²/m₀₀, | μ₀₂ = m₀₂ − m₀₁²/m₀₀, |
| μ₃₀ = m₃₀ − 3x_{c}m₂₀ + 2m₁₀x_{c}², | μ₀₃ = m₀₃ − 3y_{c}m₀₂ + 2m0₀₁y_{c}², |
| μ₁₂ = m₁₂ − 2y_{c}m₁₁ − x_{c}m₀₂ + | μ₂₁ = m₂₁ − 2x_{c}m₁₁ − y_{c}m₂₀ + |
| 2m₁₀y_{c}², | 2m₀₁x_{c}². |

Moment invariants

| | |
|---|---|
| φ = η₂₀ + η₀₂, | φ₂ = (η₂₀ − η₀₂)² + 4η₁₁², |
| φ₃ = (η₃₀ − 3η₀₂)² + (η₂₁ − 3η₀₃)², | φ₄ = (η₀₃ + η₁₂)² + (η₂₁ + η₀₃)². |

The feature list including features in the iris analyzing region is generated based on region segmentation, moment invariants are calculated for each feature. The moment invariants for effectively discriminating a feature from another feature exist. Similar images moved, rotated and scaled-up/down have similar moment invariants. The moment invariants have a difference due to discretization error from each other.

When the size variation of iris is modeled as variation of scale space, if a moment is normalized with a mean size, a size-invariant Zernike moment is generated.

A radius of the iris image which is transformed to the polar coordinates is increased by a predetermined angle, the iris image is converted into binary image in order to obtain a primary contour of the iris having the same radius.

Histograms are extracted, and it accumulates frequency numbers of gray value of pixels in the primary contour of the iris in a predetermined angle. In general, to obtain a scale space for a discontinuous signal, a continuous equation should be transformed into a discrete equation by using a square formula of integration.

If F is a smoothen curve of a scale space image, wherein the scale space image is scaled by Gaussian kernel, a zero-crossing point of a first derivative ∂F/∂x of F in a scale τ is a local minimum value or a local maximum value of the smoothen curve in the scale τ. A zero-crossing point of a second derivative ∂2F/∂2x of F is a local minimum value or a local maximum value of the first derivative ∂F/∂x of F in the scale τ. An extreme value of a gradient is a point of inflection in a circular function. The relation between the extreme point and the zero-crossing point is illustrated in FIG. 18.

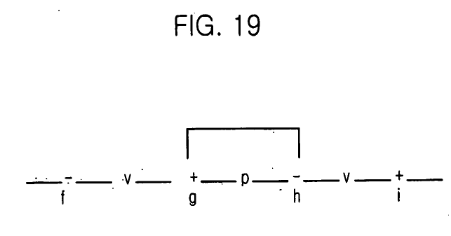

Referring to FIG. 18, the curve (a) denotes a smoothen curve of a scale image in a scale, the function F(x) has three extreme points and two minimum points. The curve (b) denotes zero-crossing points of a first derivate of the function F(x) on the extreme points and the minimum points of the curve (a). The zero-crossing points a, c, e, indicate the extreme points and the zero-crossing points b, d indicate the minimum points. The curve (c) denotes a second derivative ∂2F/∂2x of the function F and has four zero-crossing points f, g, h, i. The zero-crossing points f and h are the minimum values of the first derivate and starting points of valley regions. The zero-crossing points g and i are the extreme values of the first derivate and starting points of peak regions. In the range [g, h], a peak region of the circular function is detected. The point g is a left gray value and a zero-crossing point of the second derivate, and the sign of the first derivate function on the point g is positive. The point h is a right gray value and a zero-crossing point of the second derivate, and the sign of the first derivate function on the point h is negative. The iris can be represented by set of the zero-crossing points of the second derivate function. FIG. 19 illustrates a peak region and valley regions in FIG. 18(a). In FIG. 19, “p” denotes a peak region, “v” a valley region, “+” a change of sign of the second derivate function from positive to negative, “−” a change of sign of the second derivate function from negative to positive. A zero contour line can be obtained by detecting a peak region ranged from “+” to “−”.

According to the above method, an iris curvature feature can be illustrated, wherein the iris curvature feature represents shape and movement of inflection points of the smoothed signal and is a contour of the zero-crossing points of the second derivate. The iris curvature feature provides texture of the circular signal in whole scales. Based on the iris curvature feature, events occurred on the zero-crossing point of a primary contour scale of the shape in the iris analyzing region can be detected, the events can be localized by following the zero-crossing points in fine scale step-by-step. A zero contour of the iris curvature feature has a shape of arch, wherein top portion of the arch is close and bottom portion of the arch is open. The zero-crossing points are crossed on the peak point of the zero contours as opposite signs, which means that the zero-crossing point is not disappeared but the scale of the zero-crossing point is reduced.

A scale space filtering represents scale of the iris by handling size of filter smoothing the primary contour pixel gray values of the feature in a iris analyzing region as a continuous parameter. The filter used for the scale space filtering is a filter generated by combining a Gaussian function and a scale constant. The size of the filter used for the scale space filtering is determined based on a scale constant, e.g., a standard deviation. The size of the filer is expressed as a following equation 40.

$$\begin{matrix}f ( x , y , t ) = f ( x , y ) * g ( x , y , t ) \\ = \int {\int }_{- ∞}^{∞} f ( u , τ ) \frac{1}{2 {πτ}^{2}} \cdot \\ exp [ - \frac{{( x - u )}^{2} + {( y - τ )}^{2}}{2 {τ}^{2}} ] ⅆ u ⅆ τ\end{matrix} \qquad Eq . 40$$

In the equation 40, Ψ={x(u), y(u), uε[0,1)}, and u is a iris image descriptor generated by making the property of the iris image as a gray level and binalizing the iris image based on the threshold T. The function f(k, y) is a primary contour pixel gray histogram of the iris to be analyzed, g(x, y, τ) is a Gaussian function, (x, y, τ) is a scale space plane.

In the scale space filtering, the wider region of two-dimensional image is smoothed as the scale constant τ is larger. Second derivate of F (x, y, τ) can be obtained by applying ∇²g (x, y, τ) into f(x, y), which is expressed in a following equation 41.

$$\begin{matrix}{∇}^{2} F ( x , y , τ ) = {∇}^{2} \{ f ( x , y ) * g ( x , y , τ ) \} \\ = f ( x , y ) * {∇}^{2} g ( x , y , τ )\end{matrix} \\ \begin{matrix}{∇}^{2} g ( x , y , τ ) = \frac{{\partial }^{2} g ( x , y , τ )}{\partial {x}^{2}} + \frac{{\partial }^{2} g ( x , y , τ )}{\partial {y}^{2}} \\ = - \frac{1}{{π}^{2}} [ 1 - \frac{{x}^{2} + {y}^{2}}{2 {π}^{2}} ] exp [ - \frac{{x}^{2} + {y}^{2}}{2 {π}^{2}} ]\end{matrix} \qquad Eq . 41$$

In the scale space filtering, as the scale constant τ is increased, g (x, y, τ) is increased, and therefore, it takes a lot of time to obtain a scale space image. This problem can be solved by applying h₁, h₂, which is expressed in a following equation 42.

$${∇}^{2} g ( x , y , τ ) = {h}_{1} ( x ) {h}_{2} ( y ) + {h}_{2} ( x ) {h}_{1} ( y ) \\ {h}_{1} ( ɛ ) = \frac{1}{{( 2 π )}^{1 / 2 {ɛ}^{2}}} ( 1 - \frac{{ɛ}^{2}}{{τ}^{2}} ) exp [ - \frac{{ɛ}^{2}}{2 {τ}^{2}} ] \\ {h}_{2} ( ɛ ) = \frac{1}{{( 2 π )}^{1 / 2 {τ}^{2}}} exp [ - \frac{{ɛ}^{2}}{2 {τ}^{2}} ] \qquad Eq . 42$$

The second derivate of F (x, y, τ) is expressed in a following equation 43.

$$\begin{matrix}{∇}^{2} F ( x , y , τ ) = {∇}^{2} \{ f ( x , y ) * g ( x , y , τ ) \} \\ = {∇}^{2} g ( x , y , τ ) \neq f ( x , y ) \\ = [ {h}_{1} ( x ) {h}_{2} ( y ) + {h}_{2} ( x ) {h}_{1} ( y ) ] * f ( x , y ) \\ = {h}_{1} ( x ) * [ {h}_{2} ( y ) * f ( x , y ) ] + \\ {h}_{2} ( x ) * [ {h}_{1} ( y ) * f ( x , y ) ]\end{matrix} \qquad Eq . 43$$

In a region in which a result value obtained based on ∇²g (x, y, τ) is negative, as the scale space filtering constant is small, a plurality of meaningless peaks are generated and the number of the peaks are increased. However, if the scale filtering constant is large, e.g., 40, the filter includes the two-dimensional histogram and the peak has a shape of combining a plurality of peaks, the scale space filtering for a larger scale does not effect to find an outstanding peak of the two-dimensional histogram. In the region in which the values of x and y are larger than |3τ|, ∇²g (x, y, τ) has a very small value which -does not affect the calculation result. Therefore, ∇²g (x, y, τ) is calculated in a range from −3τ to 3τ. An image of which peak is extracted from second differential of the scale space image is referred to as a peak image.

Hereinafter, an automatic optimal scale selection will be explained.

A peak image, which includes outstanding peaks of the two-dimensional histogram and represents the shape of the histogram well, is selected, a scale constant at that time is detected at the graph, and then the optimal scale is selected. The change of the peak includes four cases as:

\textcircled{1} Generation of a new peak

\textcircled{2} Division of a peak into a plurality of peaks

\textcircled{3} Combination of a plurality of peaks into a new peak

\textcircled{4} Change of shape of peak

The peak is represented as a node in the graph, and relation between peaks of two adjacent peak images is represented by a directional peak. The node includes a scale constant at which the peak starts and a counter, a range of scale in which the peak continuously appears is recorded, and a range of scale in which the outstanding peaks simultaneously exist is determined.

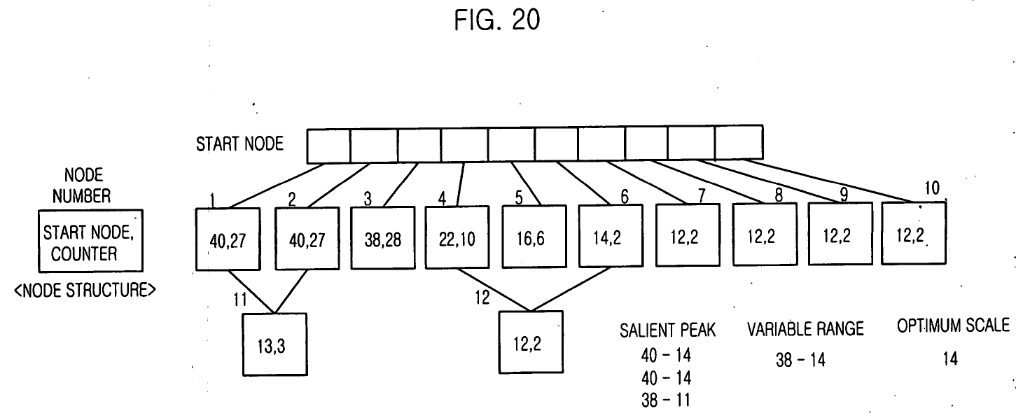

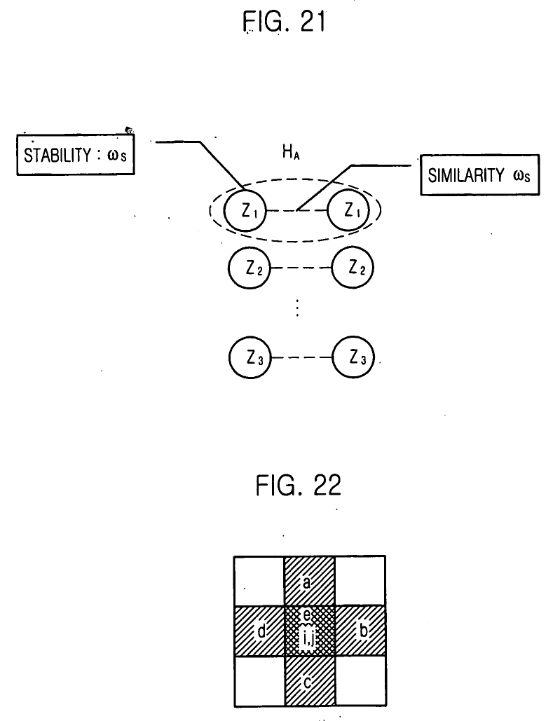

A start node is generated, nodes for the peak image corresponding to the scale constant 40 are generated, when the change of the peak corresponds to the case \textcircled{1}, \textcircled{2} or \textcircled{3}, a new node is generated, a start scale of the new node is recorded and the counter is operated. If the graph is completed, all of paths from the start node to a termination node are searched, a scale range of an outstanding peak in each path is founded. In case that a new peak is generated, a valley region in the previous peak image is changed into a peak region due to the change of the scale. If there is only one peak newly generated in a path and the scale range of the peak is larger than the scale range of the valley, since the peak can not be regarded as an outstanding peak, the scale range of the outstanding peak is not founded. The range in which the scale ranges are overlapped is determined as a variable range, the smallest scale constant within the variable range is determined as the optimum scale. (See FIG. 20)

Hereinafter, a shape descriptor extracting procedure S313 will be described.

A shape descriptor extractor 29 generates a Zernike moment based on features points extracted from the scale space and the scale illumination, and extracts based on the Zernike moment a shape descriptor which is rotation-invariant and strong to an error. At this time, 24 absolute values of the 8^{th} Zernike moment are used as the shape descriptor in order to solve the problem that the Zernike moment is sensitive to the size of the image and the light, by using the scale space and the scale.

The shape descriptor is extracted based on the normalized iris curvature feature obtained in the pre-processing procedure. Since the Zernike moment is extracted based on internal region of the iris curvature feature, and is rotation-invariant and strong to an error, the Zernike moment is widely used for a pattern recognition system. In this embodiment, as a shape descriptor for extracting shape information from the normalized iris curvature feature, 24 absolute values of the first to the 8^{th} Zernike moments except of the 0^{th} moment. Also, movement and scale normalization affect on two Zernike moments A₀₀ and A₁₁. In the normalized image, there are |A₀₀|=(2/π)^{m00}=1/πand |A₁₁|=0.

Since each of |A₀₀| and |A₁₁| has the same value in all of the normalized images, the moments are excluded from feature vector used for representing the features of the image. The 0^{th} moment represents the size of the image and is used for obtaining a size-invariant feature value. By modeling the variation in the size of the image based on variation in the scale space, the moment is normalized as a mean size, to thereby generate the Zernike moment.

The Zernike moment f(x, y) of two-dimensional image is a complex moment defined by a following equation 45. The Zernike moment is known to have rotation-invariant feature. The Zernike moment is defined as a complex polynomial set each of which element is orthogonal within a unit circle (x²+y²≦1) The complex polynomial set is defined as a following equation 44.
zp=(Vnm(x,y)|x²+y²≦1) Eq. 44

A basis function of the Zernike moment is expressed by a following equation 45, a rotational axis is a complex function defined within a unit circle (x²+y²1), Rₙₘ(ρ) is an orthogonal radial polynomial equation. Rₙₘ(ρ) is defined as the equation 45.
Vₙₘ(x,y)=Vₙₘ(ρ,θ)=Rₙₘ(ρ)e^{jmθ} Eq. 45

Where the condition n−|m|: even number and |m|≦n should be satisfied when n is an integer equal to or larger than 0, m is an integer.

In other words, degree n is repeated by m, which is expressed as: ρⁿ, ρⁿ⁻², . . . , ρ^{|m|}. Wherein ρ=\sqrt{x²+y²},

$$θ = {tan}^{- 1} ( \frac{y}{x} ) .$$

θ represents an angle between x-axis and the vector y.

Rₙₘ(ρ) is polar coordinates of Rₙₘ(x, y).

Rₙₘ(ρ) is a polar coordinate of Rₙₘ(x, y), i.e., x=ρcosθ, y=ρsinθ.

$${R}_{nm} ( ρ ) = {\sum }_{s = 0}^{( n - \vert m \vert ) / 2} {( - 1 )}^{s} \frac{( n - s ) !}{s ! ( \frac{n + \vert m \vert}{2} - s ) ! ( \frac{n - \vert m \vert}{2} - s ) !} {ρ}^{n - 2 s} \qquad Eq . 46$$

Where, R_{n,-m}( ) is equal to Rₙₘ(ρ). Rₙₘ(ρ)=ρ^{|m|}Pₛ^{(0,|m|)}(2ρ²−1) is a Jacobi's polynomial equation under a condition that s=(n-|m|)/2 , Pₛ^{(0,|m|)}(x).

A recursive equation of Jacobi's polynomial is used for calculating Rₙₘ(ρ) in order to calculate Zernike polynomial without a look-up table.

The Zernike moment for iris curvature feature f(x, y) obtained from iris within a predetermined angle by a scale-space filter is a Zernike orthogonal basis function, i.e., a projection of f(x, y) for Vₙₘ(x, y). Applying the n-th Zernike moment satisfying ρⁿ, ρⁿ⁻², . . . , ρ^{|m|}to a discrete function (not a continuous function), the Zernike moment is a complex number calculated by the Zernike moment expressed by an equation 47.

$${A}_{nm} = \frac{n + 1}{π} {\sum }_{x = 0}^{N - 1} {\sum }_{y = 0}^{M - 1} {f ( x , y ) [ {V}_{nm} ( x , y ) ]}^{*} \qquad Eq . 47$$

Wherein * denotes a complex conjugate of [Vₙₘ(x,y)].

$${A}_{nm} = \frac{n + 1}{π} {\sum }_{x} {\sum }_{y} f ( x , y ) [ {VR}_{nm} ( x , y ) + {jVI}_{nm} ( x , y ) ] , \\ {x}^{2} + {y}^{2} \leq 1 \qquad Eq . 48$$

Wherein VR is a real component of [Vₙₘ(x,y)]* and VI an imaginary component of [Vₙₘ(x,y)]*.

If the Zernike moment for the iris curvature feature f(x, y) is Aₙₘ, a Zernike moment (expressed by an equation 49) of a rotated signal is defined as equations 50 and 51.

$$\begin{matrix}{f}^{r} ( ρ , θ ) = f ( ρ , α + θ ) = F ( y cos ( α ) + x sin ( α ) , y sin ( α ) - x cos ( α ) ) & Eq . 49 \\ {A}_{nm} = \frac{n + 1}{π} {\sum }_{x} {\sum }_{y} f ( ρ , α + θ ) {V}_{nm}^{*} ( ρ , θ ) , s , t , ρ \leq 1 & Eq . 50 \\ {A}_{nm}^{r} = {A}_{nm} exp ( - j m α ) & Eq . 51 \\ \vert {A}_{nm}^{r} \vert = \vert {A}_{nm} \vert & Eq . 52\end{matrix}$$

As shown in Eq. 52, an absolute value of the Zernike moment has the same value regardless rotation of the feature. In real computation, if the order of the moments is too low, the patterns are difficult to be classified, and if the order of the moments is too high, the amount of the computation is too large. It is preferable that the order of the moment is 8 (Refer to Table 4).

TABLE 4

|A₀₀|
|A₁₁|
|A₂₀|, |A₂₂|
|A₃₁|, |A₃₃|
|A₄₀|, |A₄₂|, |A₄₄|
|A₅₁|, |A₅₃|, |A₅₅|
|A₆₀|, |A₆₂|, |A₆₄|, |A₆₆|
|A₇₁|, |A₇₃|, |A₇₅|, |A₇₇|
|A₈₀|, |A₈₂|, |A₈₄|, |A₈₆|, |A₈₈|

Since the Zernike moment is calculated based on the orthogonal polynomial equation, the Zernike moment has a rotation-invariant feature. In particular, the Zernike moment has better characteristics in iris representation, duplication and noise. However, the Zernike moment has shortcomings to be sensitive to the size and the brightness of the image. The shortcoming related to the size of the image can be solved based on the scale-space of the image. Using Pyramid algorithm, a pattern of the iris is destroyed due to the re-sampling of the image. However, the scale-space algorithm has better feature point extraction characteristic than the Pyramid algorithm, because the scale-space algorithm uses the Gaussian function. Modifying the Zernike moment, which is invariant to movement, rotation and scale of the image, can be extracted (refer to an equation 53). In other words, the image is smoothed based on the scale-space algorithm, and the smoothed image is normalized, the Zernike moment is robust to the size of the image.

$$\begin{matrix}{A}_{nm} = \frac{n + 1}{π} \int {\int }_{ρ , θ} log {\vert {F}_{N} ( {ρ}^{2} , θ ) \vert}^{2} {V}_{nm}^{*} ( ρ , θ ) ρ ⅆ ρ ⅆ θ \\ = \frac{n + 1}{π} \int {\int }_{ρ , θ} log {\vert {F}_{N} ( ρ , θ ) \vert}^{2} \frac{{V}_{nm}^{*} ( \sqrt{ρ} , θ )}{2 ρ} ρ ⅆ ρ ⅆ θ \\ = \frac{n + 1}{π} {\sum }_{{k}_{1}} {\sum }_{{k}_{2}} log {\vert {F}_{N} ( {k}_{1} , {k}_{2} ) \vert}^{2} \frac{{V}_{nm}^{*} ( \sqrt{ρ} , θ )}{2 ρ}\end{matrix} \qquad Eq . 53$$

The modified rotation invariant transform has a characteristic that a low frequency component is emphasized. On the other hand, when modeling local luminance variation expressed by an, equation 54, a brightness-invariant Zernike moment as expressed by an equation 55 can be generated by normalizing the moment by a mean brightness Z00.

$$\begin{matrix}{f}^{t} ( {x}_{t} , {y}_{t} ) = {a}_{L} f ( {x}_{t} , {y}_{t} ) & Eq . 54 \\ \frac{Z ( {f}^{t} ( x , y ) )}{{m}_{{f}^{t}}} = \frac{{a}_{L} z ( f ( x , y ) )}{{a}_{L} {m}_{f}} = \frac{Z ( f ( x , y ) )}{{m}_{f}} & Eq . 55\end{matrix}$$

Wherein f(x, y) denotes an iris image, f^{t}(x, y) an iris image under a new luminance, a_{L} a local luminance variation rate, m_{f} a mean luminance (a mean luminance of the smoothed image), and Z a Zernike moment operator.

Though the iris image inputted based on the above features is modified by the movement, the scale and the rotation of the iris image, the iris pattern, which is modified in a similar as visual characteristics of the human being, can be retrieved. In other words, the shape descriptor extractor 29 of FIG. 2 extracts features of the iris image from the input image, the reference value storing unit 30 of FIG. 2 or the iris pattern registering unit 14 of FIG. 1 stores the features of the iris image on the iris database (DB) 15 at steps S314 and S315.

If a query image is received at step S316, the shape descriptor extractor 29 of FIG. 2 or the iris pattern feature extractor 13 of FIG. 1 extracts shape descriptors of the query image (hereinafter, which is referred to as a “query shape descriptor”). The iris pattern recognition unit 16 compares the query shape descriptor and the shape descriptors stored on the iris DB 15 at step S317, retrieves images corresponding to the shape descriptor having the minimum distance from the query shape descriptor, and outputs the retrieved image to the user. The user can see the retrieved iris images rapidly.

The steps S314, 315 and 317 will be described in detail.

The reference value storing unit 30 of FIG. 2 or the iris pattern registering unit 14 of FIG. 1 classifies the images as template type based on stability of the Zernike moment and similarity according to a Euclidean distance, and stores the features of the iris image on the iris database (DB) 15 at step S314, wherein the stability of Zernike moments relates to sensitivity which is four-directional standard deviation of the Zernike moment. In other words, the image patterns of the iris curvature f(x, y) are projected to the Zernike complex polynomial equation Vₙₘ(x, y) on 25 spaces, and classified. The stability is obtained by comparing feature points of the current image and the previous image, i.e., comparison of the locations of the feature points. The similarity is obtained by comparing distance of areas. Since there are many components of the Zernike moment, the area is not a simple area, the component is referred to as a template. When defining an image analysis region of the image, sample data of the image is gathered. Based on the sample data of the image, the similarity and the stability are obtained.

The image recognizing/verifying unit 31 of FIG. 2 or the iris pattern recognition unit 16 of FIG. 1 recognizes a similar iris image by matching features of models which are modeled based on the stability and the similarity of the Zernike moments, and verifies the similar iris image based on a least square (LS) algorithm and a least median of square (LmedS) algorithm. At this time, the distance of the similarity is calculated based on Minkowsky Mahalanbis distance.

The present invention provides a new similarity measuring method appropriate for extracting feature invariant to the size and luminance of the image, which is generated by modifying the Zernike moments.

The iris recognition system includes a feature extracting unit and a feature matching unit.

In the off-line system, the Zernike moment is generated based on the feature point extracted in the scale space for the registered iris pattern. In real time recognition system, the similar iris pattern is recognized by statistical matching of the models and the Zernike moment generated based on the feature point, and verifies the similar iris pattern by using the LS algorithm and the LmedS algorithm.

Classification of iris images into templates will be, described in detail.

In the present invention, the statistical iris recognition method recognizes the iris by reflecting the stability of the Zernike moment and the similarity of characteristics to the model statistically.

A basis definition of the modeling is followed.

An input image is denoted by S, a set of models M={Mi}, i=1, 2, . . . , N_{M}, wherein N_{M} is the number of the models, a set of the Zernike moments of the input image S Z={Zi}, i=1, 2, . . . , Nₛ, wherein Nₛ is the number of the Zernike moments of the input image S. The Zernike moment of the model corresponding to the i-th Zernike moment of the input image S is expressed as Zi={Zᵢ^{j}}, j=1, 2, . . . , N_{c}, wherein N_{c} is the number of the corresponding Zernike moments.

The probability iris recognition finds a mode Mi which makes a maximum probability value when the input image S is received, which is expressed by an equation 56.

$${argmax}_{{M}_{i}} P ( {M}_{i} \vert S ) \qquad Eq . 56$$

A hypothesis as a following equation 57 can be made based on candidate model Zernike moments corresponding to the Zernike moments of the input image.
Hᵢ={{\hat{Z}ᵢ₁, Z₁)∩{\hat{Z}ᵢ₂, Z₂)∩. . . {\hat{Z}_{iN}_{_{S}},Z_{N}_{_{S}})}, i=1,2, . . . , N_{H} Eq. 57

Where N_{H} denotes the number of elements of product of the model Zernike moments corresponding to the input image.

The total hypothesis set can be expressed as:
H={Hᵢ∪H₂. . . H_{N}_{_{S}}} Eq. 58

Since the hypothesis H includes candidates of the features extracted from the input image S, S can be replaced by H. If Bayes' theory is applied to the equation 56, an equation 59 can be obtained as:

$$P ( {M}_{i} \vert H ) = \frac{P ( H \vert {M}_{i} ) P ( {M}_{i} )}{P ( H )} \qquad Eq . 59$$

If the probability that each of irises is inputted is the same and independent from each other, the equation 59 can be expressed by an equation 60.

$$P ( {M}_{i} \vert H ) = \frac{{\sum }_{h = 1}^{{N}_{H}} P ( {H}_{h} \vert {M}_{i} ) P ( {M}_{i} )}{P ( {H}_{h} )} \qquad Eq . 60$$

In Eq. 60, according to theorem of total probability, the denominator can be expressed as:

$$P ( {H}_{i} ) = {\sum }_{i = 1}^{{N}_{H}} P ( {H}_{i} \vert {M}_{i} ) P ( {M}_{i} )$$

In the equation, it is most important to obtain a value of the probability P(Hₕ|Mᵢ). In order to define a transcendental probability P(Hₕ|Mᵢ), a new concept on the stability is introduced.

The transcendental probability P(Hₕ|Mᵢ) has a large value when the stability w _{S} and the similarity ww _{D} are large. The stability represents incompleteness of the feature points, and the similarity is obtained by the Euclidean distance between the features.

First, the stability \overline{ω}_{S} will be described in detail.

The stability of the Zernike moments is inverse proportion to a sensitivity of the Zernike moment to variation in the location of the feature points. The sensitivity of the Zernike moment represents standard deviation of the Zernike moment in four directions from the center point. The sensitivity of the Zernike moment is expressed by a following equation 61. The stability of the Zernike moment is inverse proportion to the sensitivity of the Zernike moment. As the sensitivity of the Zernike moment is lower, the stability of location error of the feature point is higher.

$$SENSITIVITY = \sqrt{\frac{1}{4}} [ \begin{matrix}{‖ {Z}_{a} - {Z}_{b} ‖}^{2} + \\ {‖ {Z}_{b} - {Z}_{c} ‖}^{2} + \\ {‖ {Z}_{c} - {Z}_{a} ‖}^{2}\end{matrix} ] \qquad Eq . 61$$

Next, the similarity \overline{ω}_{D} will be described in detail.

As the Euclidean distance from the model feature corresponding to the Zernike moment of the input image is shorter, the similarity \overline{ω}_{D} is larger. The similarity \overline{ω}_{D} is expressed by a following equation 62.

$${ϖ}_{D} ∝ \frac{1}{distance} \qquad Eq . 62$$

The recognition result can be obtained by classification of the patterns after performing pre-processing, e.g., normalization, which is expressed by a following equation 63 as:

$${A}_{nm} = \frac{n + 1}{π} {\sum }_{x} {\sum }_{y} f ( x , y ) [ {VR}_{nm} ( x , y ) + {jVI}_{nm} ( x , y ) ] , \\ {x}^{2} + {y}^{2} \leq 1 \qquad Eq . 63$$

If n=0, 1, . . . , 8, m=0, 1, . . . , 8, the area pattern of the iris curvature f(x, y) is projected to the Zernike complex polynomial Vₙₘ(x,y) on 25 spaces, X=(x₁, x₂, . . . , xₘ) and G=(g₁, g₂, . . . , gₘ) are classified as a template in the database and stored. The distance frequently used for the iris recognition is classified as a Minkowsky Mahalanbis distance.

$$D ( X , G ) = {\sum }_{i = 1}^{m} {\vert {x}_{i} - {g}_{i} \vert}^{q} \qquad Eq . 64$$

Where xᵢ denotes a magnitude of the i-th Zernike moment of the image stored on the DB, and gᵢ a magnitude of the i-th Zernike moment of the query image.

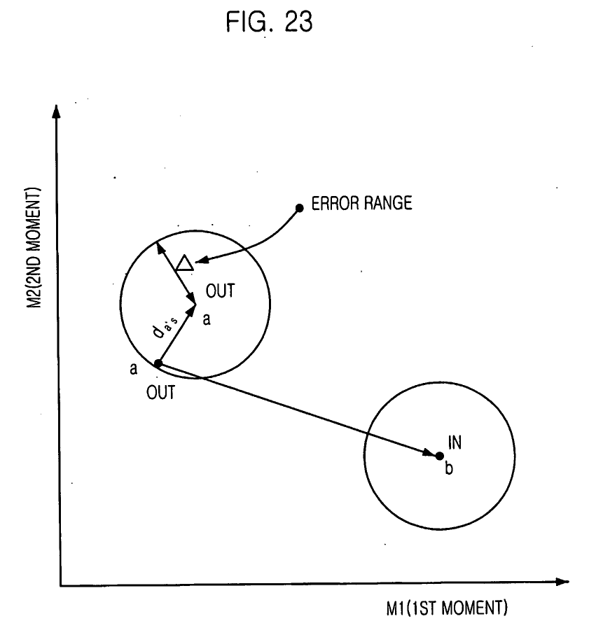

In case of q=25, the image having the shortest Minkowsky's distance within a predetermined permitted limit is determined as the iris image corresponding to the query image. If there is no image having the shortest Minkowsky's distance within the predetermined permitted limit, it is determined that there is no studied image circular shape. For only easy description, it is assumed that there are two iris images in the dictionary. Referring to FIG. 23, input patterns of the iris image, wherein the first and the second ZMMs of the rotated iris images in a two-dimensional plane, are located on points a and b. Euclidean distances da′a, da′b between the points a and b are obtained, based on a following equation 65, wherein the Euclidean distance is an absolute distance in case of q=1. Euclidean distances are da′a<da′b, da′a<Δ, which shows that the iris images are rotated. However, if the iris images are the same, ZMMs of the iris images are identical with the predetermined permitted limit.

$$D ( X , G ) = {\sum }_{i = 1}^{m} {\vert {x}_{i} - {g}_{i} \vert}^{q} \qquad Eq . 65$$

For retrieving the iris image, shape descriptors of the query image and images stored in the iris database 15 are extracted, and then the iris image similar to the query image is retrieved based on the shape descriptors. The distance between the query image and the image stored in the iris database 15 is obtained based on a following equation 66 (Euclidean distance in case of q=2), the similarity S is obtained by a following equation 67.

$$\begin{matrix}D ( X , G ) = \sqrt{{\sum }_{i = 1}^{m} {( {x}_{i} - {g}_{i} )}^{2}} & Eq . 66 \\ S = \frac{1}{1 + D} & Eq . 67\end{matrix}$$

The similarity S is normalized and becomes a value between 0 and 1. Accordingly, the transcendental probability P(Hₕ|Mᵢ) can be obtained based on the stability and the similarity, which is expressed by a following equation 68.

$$P ( {H}_{h} \vert {M}_{i} ) = {{X}_{j = 1}}^{{N}_{S}} P ( ( {\hat{Z}}_{k} , {Z}_{j} \vert {M}_{i} ) \qquad Eq . 68$$

Where P((\hat{Z}ₖ,Zⱼ|Mᵢ) is defined as:

$$P \text{(} ( {\hat{Z}}_{k} , {Z}_{j} \vert {M}_{i} ) = \{ \begin{matrix}exp [ \frac{dist ( {\hat{Z}}_{k} , {Z}_{j} )}{{ϖ}_{s} α} ] & if {\hat{Z}}_{k} ∈ \hat{Z} ( {M}_{i} ) \\ ɛ & else\end{matrix} \qquad Eq . 69$$

Where Ns is the number of interest points of the input image, α is a normalization factor obtained by multiplying a threshold of the similarity and a threshold of the stability, and ε is assigned if the corresponding model feature does not belong to a certain model. In this embodiment, ε is 0.2. To find matching pairs, it is used an approximate nearest neighbor (ANN) search algorithm, which takes log time for linear search space.

To find a solution increasing the probability, a verifying procedure of the retrieved image based on LS and LmedS algorithms will be described.

The retrieved iris is verified by matching the input image and the model images. Final feature of the iris can be obtained through the verification. To find accurate matching pairs, the image is filtered based on the similarity and the stability used for probabilistic iris recognition, and outlier is minimized by regional space matching.

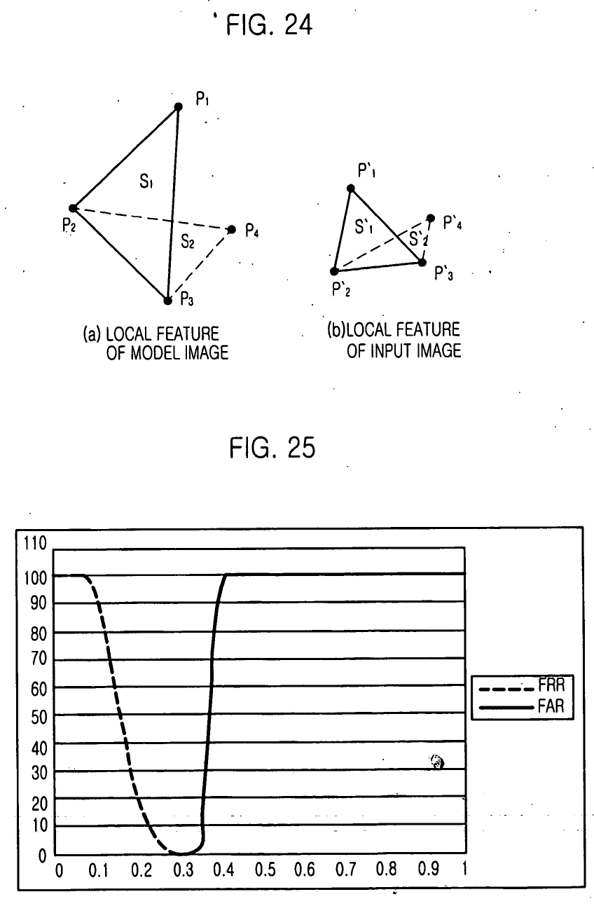

FIG. 24 is a diagram showing a method for matching local regions based on area ratio in accordance with an embodiment of the present invention.

In continuous four points, values

$$\frac{Δ {P}_{2} {P}_{3} {P}_{4}}{Δ {P}_{1} {P}_{2} {P}_{3}}$$

for the model and

$$\frac{Δ {P}_{2}^{′} {P}_{3}^{′} {P}_{4}^{′}}{Δ {P}_{1}^{′} {P}_{2}^{′} {P}_{3}^{′}}$$

for the input image are obtained, if the ratio of the two values is larger than the permitted value, the fourth pair is deleted. At this time, three pairs are assumed to be matched.

Homography is obtained based on the matching pairs. The homography is calculated based on the least square (LS) algorithm by using at least three pairs of feature points. The homography which makes the outlier a minimum value is selected as an initial value, and the homography is optimized based on the least median of square (LmedS) algorithm. The models are aligned to the input images based on the homography. If the outlier is over 50%, align of the models is regarded as fail. As the number of matched models is larger than the number of the other models, the recognition capacity becomes higher. Based on this feature, a discriminative factor is proposed. The discriminative factor (DF) is defined as:

$$DF = \frac{{N}_{C}}{{N}_{D}} \qquad Eq . 70$$

Where N_{C} is the number of the matching pairs of the models identical to the query iris image, N_{D} is the number the matching pairs of the other models.

DF is an important factor to select factors of the recognition system. The order of the Zernike moments for the image having the Gaussian noise (of which the standard deviation is 5) is 20. When the size of the local image of which center point is a feature point is 21×21, the DF has the largest value.

The retrieval performance of the iris recognition system will be described.

To evaluate the performance of the iris recognition system, a plurality of iris images are necessary. Registration and recognition for a certain person are necessary, and the number of the necessary iris images is increased. Also, since it is important the experiment for the iris recognition system in various environments in the sexual distinction, age and wearing glasses, in order to obtain accurate performance result of the recognition experiment, a fine plan for the experiments is necessary.

In this embodiment, iris images of 250 persons are used, wherein the iris images are captured by a camera. 500 false acceptance rate (FAR) images for registering 250 users (left and right irises) and 300 false rejection rate (FRR) images obtained from 15 users are used in this embodiment. However, image acquisition according to time and environment should be studied. Table 5 shows data used for evaluating the performance of the iris recognition system.

TABLE 5

| | | | |
|---|---|---|---|
| Number of | 250 | Male | Female |
| Users | | 168 | 82 |

| | | |
|---|---|---|
| Wearing | Wearing Contact | Not |
| Glasses | lenses | Wearing |
| 44 | 16 | 190 |

| | |
|---|---|
| Obtained Data | (FAR: 500) (FRR: 300) |
| User | |
| Total Number | 250 * 2 = 500, 15 * 20 = 300 |
| of Data | |

The pre-processing procedure is very important to improve performance of the iris recognition system.

TABLE 6

| | Procedure | | |
|---|---|---|---|
| | F1 | F1 + F2 | F1 + F2 + F3 |
| Processing Time | 0.1 | 0.2 | 0.4 |

F1: grids detection
F2: pupil location detection
F3: edge component detection

TABLE 7

| | Male | Female | Total |
|---|---|---|---|
| Not Wearing | 110 | 80 | 190 |
| Wearing Glasses | 10 | 34 | 44 |
| Wearing Contact | 8 | 8 | 16 |
| lenses | | | |
| Total | 168 | 82 | 230 |

TABLE 8

| | | Number | Rate (%) | |
|---|---|---|---|---|
| Normal | Normal detection | 500 | 100 | 100 |
| Images | Inner boundary detection fail | 0 | 0 | |
| | Outer boundary detection fail | 0 | 0 | |
| Abnormal | Shortage of boundary detection | 0 | 0 | 0 |
| Images | information | | | |
| | Error image | 0 | 0 | |

| | | |
|---|---|---|
| Total | 500 | 100 |

In general, the recognition system is evaluated by two error rates. The two error rates include a false rejection rate (FRR) and a false acceptance rate (FAR). FRR is a probability in which a user fails to authenticate himself/herself when trying to authenticate by using. his/her iris images. FAR is a probability in which another user success to authenticate himself/herself when trying to authenticate by using his/her iris images. In other words, in order that the biometric recognition system provides a highest stability, the biometric recognition system should recognize the registered user accurately when the registered user tires to be authenticated, and the biometric recognition system should deny the unregistered user when the unregistered user tires to be authenticated. These principles of the biometric recognition system should be also applied to the iris recognition system.

According to application field of the iris recognition system, the error rates can be selectively adjusted. However, to increase performance of the iris recognition system, both of the two error rates should be decreased.

A calculating procedure of the error rates will be described.

After calculating distances between the iris images acquired from the same person based on a similarity calculation method, a distribution of frequencies in the distances is calculated, which is referred to as “authentic”. A distribution of frequencies in the distances between the iris images acquired from different persons is calculated, which is referred as to “imposter”. Based on the authentic and the imposter, a boundary value minimizing the FRR and the FAR is calculated. The boundary value is referred to as “threshold”. The studied data are used for the above procedures. The FRR and the FAR according to the distribution are illustrated in FIG. 25.

$$FAR = \frac{number of accepted imposter claims}{total number of imposter accesses} \times 100 \% \\ FRR = \frac{number of rejected client claims}{total number of client accesses} \times 100 \% \qquad Eq . 71$$

The procedure calculating the two error rates for the iris recognition system will be described.

If the distance between the studied data and the iris image of the same user is smaller than the threshold, the user is authenticated. However, if the distance is larger than the threshold, the iris image is determined to be different from the studied data and the user is denied. These procedures are repeated, the number of rejected client claims to the total number of client accesses is obtained as FRR.

FAR is calculated by comparing the studied data with the iris images of the unregistered user. In other words, the registered user is compared with another user unregistered. If the distance between the studied data and the iris image of the user is smaller than the threshold, the user is determined as the same person. However, if the distance is larger than the threshold, the user is determined as a different person. These procedures are repeated, the number of accepted imposter claims to the total number of imposter accesses is obtained as FAR.

In the present invention, for the verification performance evaluation, FAR and FRR are performed on data selected at the pre-processing.

The authentic distribution and the imposter distribution will be described.

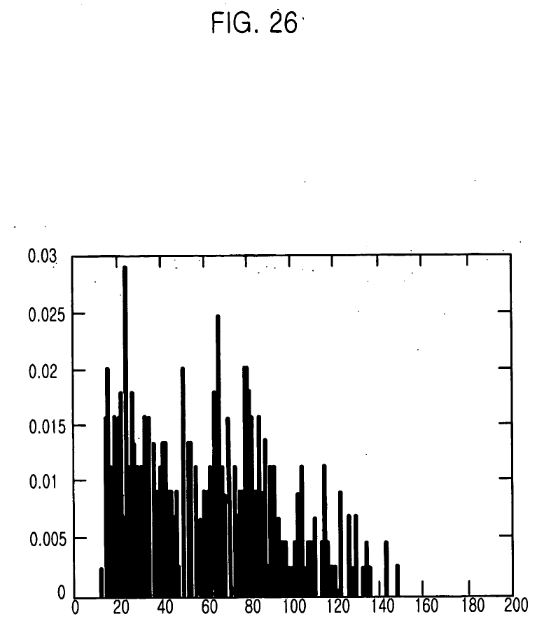

After calculating distances between the iris images acquired from the same person based on a similarity calculation method, a distribution of frequencies in tie distances is calculated, which is referred to as “authentic”. The authentic distribution is illustrated in FIG. 26. In this drawing, an x-axis denotes a distance and a y-axis a frequency.

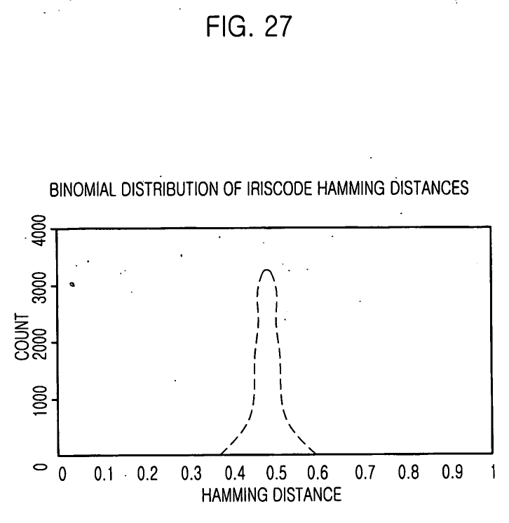

FIG. 27 is a graph showing a distribution in distances between iris images of different persons where an x-axis denotes a distance and a y-axis a frequency.

It will be described selection of thresholds for the authentic distribution and the imposter distribution.

In general, FRR and FAR are varied according to the threshold and can be adjusted according to the application field. The threshold should be carefully adjusted.

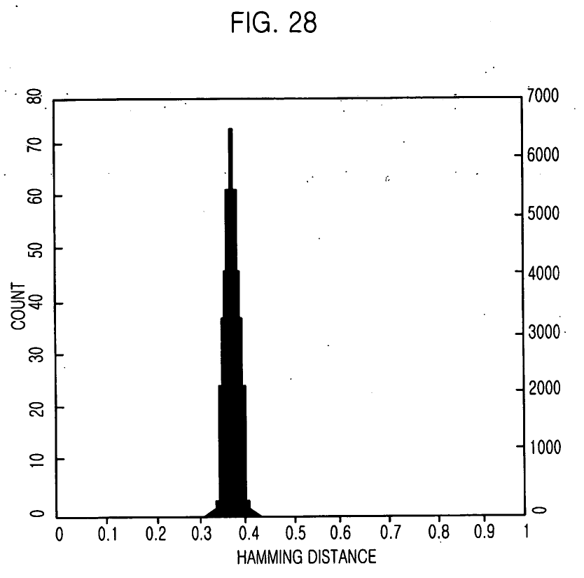

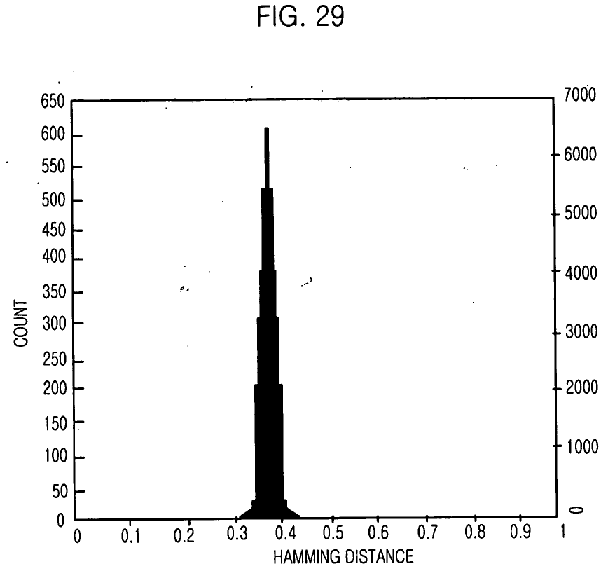

FIG. 28 is a graph showing an authentic distribution and an imposter distribution.

The threshold is selected based on the authentic distribution and the imposter distribution. The iris recognition system performs authentication based on the threshold of an equal error rate (EER). The threshold of the EER is calculated by a following equation 72 expressed as:

$$Threshold = \frac{{σ}_{A} \times {μ}_{1} \times {σ}_{1} \times {μ}_{A}}{{σ}_{A} \times {μ}_{1}} \qquad Eq . 72$$

σ_{A}: standard deviation of authentic distribution

σ₁: standard deviation of Imposter distribution

μ_{A}: mean of authentic distribution

μ₁: mean of Imposter distribution

The iris data are classified into studied data and text data, and the experiment result is represented in Table 9.

It takes about 5 to 6 seconds for registration of the image and about 1 to 2 seconds for authentication of the query image.

TABLE 9

| | |
|---|---|
| FRR | 5% |
| FAR | 15% |

The present invention can be implemented and stored in a computer readable recording medium, e.g., CD-ROM, a random access memory (RAM), a read only memory (ROM), a floppy disk, a hard disk, and a magneto-optical disk.

While the present invention has been described with respect to certain preferred embodiments, it will be apparent to those skilled in the art that various changes and modifications may be made without departing from the scope of the invention as defined in the following claims.

1. A method for detecting a pupil for iris recognition, comprising the steps of:
a) detecting light sources in the pupil from an eye image as two reference points;
b) determining first boundary candidate points located between the iris and the pupil of the eye image, which cross over a straight line between the two reference points;
c) determining second boundary candidate points located between the iris and the pupil of the eye image, which cross over a perpendicular bisector of a straight line between the first boundary candidate points; and
d) determining a location and a size of the pupil by obtaining a radius of a circle and coordinates of a center of the circle based on a center candidate point, wherein the center candidate point is a center point of perpendicular bisectors of straight line between the neighbor boundary candidate points, to thereby detect the pupil.

2. The method as recited in claim 1, wherein said step a) includes the steps of:
a1) obtaining geometrical differences between light images on the eye image;
a2) calculating a mean value of the geometrical differences and modeling the geometrical differences as a Gaussian wave to generate templates; and
a3) matching the templates so that the reference points located in the pupil of the eye image are selected, to thereby detect two reference points.

3. The method as recited in claim 1, wherein said step b) includes the steps of:
b1) extracting a profile representing variation of pixels on a direction of X-axis based on the two reference points;
b2) generating a boundary candidate mask corresponding to a tilt and detecting two boundary candidates of the primary signal crossing the reference points on the X-axis; and
b3) generating a boundary candidate wave based on convolution of the profile and the boundary candidate mask, and selecting the boundary candidate points based on the boundary candidate wave.

4. The method as recited in claim 3, wherein in said step c), another boundary candidate points are determined on the perpendicular line of the center point bisecting the straight line between the first boundary candidate points as the same method as said step b).

5. The method as recited in claim 1, wherein since the curvature of the pupil is different, a radius of the pupil is obtained by a magnified maximum coefficients algorithm, coordinates of the center point of the pupil are obtained by a bisecting algorithm, a distance between the center point and the radius of the pupil in counterclockwise is obtained, and a graph is illustrated in which x-axis denotes a rotation angle and y-axis denotes the radius of the pupil.

6. A method for extracting a shape descriptor for iris recognition, the method comprising the steps of:
a) extracting a feature of an iris under a scale-space and/or a scale illumination;
b) normalizing a low-order moment with a mean size and/or a mean illumination, to thereby generate a Zernike moment which is size-invariant and/or illumination-invariant, based on the low-order moment; and
c) extracting a shape descriptor which is rotation-invariant, size-invariant and/or illumination-invariant, based on the Zernike moment.

7. The method as recited in claim 6, further comprising the steps of:
establishing an indexed iris shape grouping database based on the shape descriptor; and
retrieving an indexed iris shape group based on an iris shape descriptor similar to that of a query image from the iris shape grouping database.

8. A method for extracting a shape descriptor for iris recognition, the method comprising the steps of:
a) extracting a skeleton from the iris;
b) thinning the skeleton, extracting straight lines by connecting pixels in the skeleton, obtaining a line list; and
c) normalizing the line list and setting the normalized line list as a shape descriptor.

9. The method as recited in claim 6, further comprising the steps of:
establishing a iris shape database of dissimilar shape descriptor by measuring dissimilarity of the images in an indexed similar iris shape group based on the shape descriptor; and
retrieving an iris shape matched to a query image from the iris shape database.

10. The method as recited in claim 9, wherein the step of retrieving an iris image includes the steps of:
comparing shape descriptors in the iris shape database and a shape descriptor of the query image;
measuring each distance between the shape descriptors in the iris shape database and the shape descriptor of the query image;
setting summation value of the minimum values of the distances as the dissimilarity values; and
selecting the image having a small value among the dissimilarity values as a similar image.

11. An apparatus for extracting a feature of an iris, comprising:
image capturing means for digitalizing and quantizing an image and obtaining an appropriate image for iris recognition;
a reference point detecting means for detecting reference points in a pupil from the image, and detecting an actual center point of the pupil;
boundary detecting means for detecting an inner boundary between the pupil and the iris and an outer boundary between the iris and a sclera, to thereby extract an iris image from the image;
image coordinates converting means for converting a coordinates of the iris image from a Cartesian coordinates system to a polar coordinates system, and defining the center point of the pupil as an origin point of the polar coordinates system;
image analysis region defining means for classifying analysis regions of the iris image in order to use an iris pattern as a feature point based on clinical experiences of the iridology;
image smoothing means for smoothing the image by performing a scale space filtering of the analysis region of the iris image in order to clearly distinguish a brightness distribution difference between neighboring pixels of the image;
image normalizing means for normalizing a low-order moment used for the smoothen image with a mean size; and
shape descriptor extracting means for generating a Zernike moment based on the feature point extracted in a scale space and a scale illumination, and extracting a shape descriptor which is rotation-invariant and noise-resistant by using Zernike moment.

12. The apparatus as recited in claim 11, further comprising: reference value storing means for storing a reference value as a template by comparing a stability of the Zernike moment and a similarity of Euclid distance.

13. The apparatus as recited in claim 12, wherein in said reference value storing means, the Zernike moment, which is generated based on the feature point extracted under the scale space and the scale illumination, is stored as the reference value.

14. The apparatus as recited in claim 11, wherein said image capturing means captures an eye image appropriate for the iris recognition through an image selection process having an eye blink detection, a pupil location detection, and distribution of vertical edge components, after digitalizing and quantizing the eye image.

15. The apparatus as recited in claim 14, wherein said reference point detecting means removes edge noise based on an edge enhancing diffusion (EED) algorithm using a diffusion filter, diffuses the iris image by performing a Gaussian blurring, changing a threshold used for binalizing the iris image based on a magnified maximum coefficients algorithm, to thereby obtain an actual center point of the pupil.

16. The apparatus as recited in claim 15, wherein the EED algorithm performs much diffusion in the same direction with the edge and less diffusion in the vertical direction to the edge.

17. The apparatus as recited in claim 15, wherein said boundary detecting means detects a pupil by obtaining a pupil boundary between the pupil and the iris, a radius of the circle and coordinates of the center point of the pupil and determining the location and the size of the pupil, and detects an outer boundary between the iris and a sclera based on arcs which are not necessarily concentric with the pupil boundary.

18. The apparatus as recited in claim 15, wherein said boundary detecting means detects the pupil in real time by iteratively changing the threshold, obtains a radius of the pupil based on a magnified maximum coefficients algorithm because the curvature of the pupil is different, obtains coordinates of the center point of the pupil based on a bisecting algorithm, obtains a distance between the center point and the radius of the pupil in counterclockwise, and represents a graph is illustrated in which x-axis denotes a rotation angle and y-axis denotes the radius of the pupil, to thereby detect an accurate boundary.

19. The apparatus as recited in claim 14, wherein the analysis region includes the image except an eyelid, eyelashes or a predetermined part that is blocked off by mirror reflection from illumination, and
wherein the analysis region is subdivided into a sector 1 at right and left 6 degree based on the 12 clock direction, a sector 2 at 24 degrees, in the clock-wise, a sector 3 at 42 degree, a sector 4 at 9 degree, a sector 5 at 30 degree, a sector 6 at 42 degree, a sector 7 at 27 degree, a sector 8 at 36 degree, a sector 9 at 18 degree, a sector 10 at 39 degree, a sector 11 at 27 degree, a sector 12 at 24 degree and a sector 13 at 36 degree, the 13 sectors are subdivided into 4 circular regions based on the pupil, and each circular region is called as a sector 1-4, a sector 1-3, a sector 1-2, and a sector 1-1.

20. The apparatus as recited in claim 18, wherein said image smoothing means performs 1-order scale-space filtering that provides the same pattern regardless of the size of the iris pattern image by using a Gaussian cannel with respect to a one-dimensional iris pattern image of the same radiuses around the pupil, obtains an edge, which is a zero-crossing point, and extracts the iris features in two-dimensional by accumulating the edge by using an overlapped convolution window.

21. The apparatus as recited in claim 18, wherein said image normalizing means normalizes the moment into a mean size based on a low-order moment in order to obtain a feature quantity, to thereby generate a Zernike moment which is rotation-invariant but sensitive to size and illumination of the image into a Zernike moment which is size-invariant, and normalizes the moment into the mean brightness, if a change in a local illumination is modeled into a scale illumination change, to thereby generate a Zernike moment which is illumination-invariant.

22. A system for recognizing an iris, comprising:
image capturing means for digitalizing and quantizing an image and obtaining an appropriate image for iris recognition;
reference point detecting means for detecting reference points in a pupil from the image, and detecting an actual center point of the pupil;
boundary detecting means for detecting an inner boundary between the pupil and the iris and an outer boundary between the iris and a sclera, to thereby extract an iris image from the image;
image coordinates converting means for converting a coordinates of the iris image from a Cartesian coordinates system to a polar coordinates system, and defining the center point of the pupil as an origin point of the polar coordinates system;
image analysis region defining means for classifying analysis regions of the iris image in order to use an iris pattern as a feature point based on clinical experiences of the iridology;
image smoothing means for smoothing the image by performing a scale space filtering of the analysis region of the iris image in order to clearly distinguish a brightness distribution difference between neighboring pixels of the image;
image normalizing means for normalizing a low-order moment used for the smoothen image as a mean size;
shape descriptor extracting means for generating a Zernike moment based on the feature point extracted in a scale space and a scale illumination, and extracting a shape descriptor which is rotation-invariant and noise-resistant by using Zernike moment;
reference value storing means for storing a reference value as a template by comparing a stability of the Zernike moment and a similarity of Euclid distance; and
verifying/authenticating means for verifying/authenticating the iris by matching the feature quantities between models each of which represent the stability and the similarity of the Zernike moment of the query iris image in statistical.

23. The system as recited in claim 22, wherein said verification means recognizes the iris based on a least square (LS) algorithm and a least media of square (LmedS) algorithm, to thereby recognize the iris rapidly and precisely.

24. The system as recited in claim 22, wherein said verifying/authenticating means performs filtering of the moment of the image based on the similarity and the stability used for probability object recognition and matches the stored reference value moment to a local-space in order to obtain an outlier,
wherein the outlier allows the system to confirm or disconfirm the identification of the person and evaluate confirm level of the decision,
wherein a recognition rate is obtained by discriminative factor (DF), the DF has a high recognition ability when a matching number of the input image and the right model is more than a matching number of the input image and the wrong model.

25. The system as recited in claim 22, wherein in extraction of a shape descriptor,
an image appropriate for an iris recognition is obtained through a digital camera, reference points in the pupil are detected, a pupil boundary between the pupil and the iris is defined, and an outer boundary between the iris and a sclera is detected based on arcs which are not necessarily concentric with the pupil boundary;
1-order scale-space filtering, which provides the same pattern regardless of the size of the iris pattern image by using a Gaussian cannel with respect to a one-dimensional iris pattern image of the same radiuses around the pupil is performed, an edge, which is a zero-crossing point, is obtained, and the iris features in two-dimensional is extracted by accumulating the edge by using an overlapped convolution window;
the moment is normalized into a mean size based on a low-order moment in order to obtain a feature quantity, to thereby generate a Zernike moment which is rotation-invariant but sensitive to size and illumination of the image into a Zernike moment which is size-invariant, and the moment is normalized into a mean brightness, if a change in a local illumination is modeled into a scale illumination change, to thereby generate a Zernike moment which is illumination-invariant.

26. A method for extracting a feature of an iris, comprising the steps of:
a) digitalizing and quantizing an image and obtaining an appropriate image for iris recognition;
b) detecting reference points in a pupil from the image, and detecting an actual center point of the pupil;
c) detecting an inner boundary between the pupil and the iris and an outer boundary between the iris and a sclera, to thereby extract an iris image from the image;
d) converting a coordinates of the iris image from a Cartesian coordinates system to a polar coordinates system, and defining the center point of the pupil as an origin point of the polar coordinates system;
e) classifying analysis regions of the iris image in order to use an iris pattern as a feature point based on clinical experiences of the iridology;
f) smoothing the image by performing a scale space filtering of the analysis region of the iris image in order to clearly distinguish a brightness distribution difference between neighboring pixels of the image;
g) normalizing a low-order moment used for the smoothen image as a mean size; and
h) generating a Zernike moment based on the feature point extracted in a scale space and a scale illumination, and extracting a shape descriptor which is rotation-invariant and noise-resistant by using Zernike moment.

27. The method as recited in claim 26, further comprising the step of:
i) storing a reference value as a template by comparing a stability of the Zernike moment and a similarity of Euclid distance.

28. The method as recited in claim 26, wherein the analysis region includes the image except an eyelid, eyelashes or a predetermined part that is blocked off by mirror reflection from illumination, and
wherein the analysis region is subdivided into a sector 1 at right and left 6 degree based on the 12 clock direction, a sector 2 at 24 degrees, in the clock-wise, a sector 3 at 42 degree, a sector 4 at 9 degree, a sector 5 at 30 degree, a sector 6 at 42 degree, a sector 7 at 27 degree, a sector 8 at 36 degree, a sector 9 at 18 degree, a sector 10 at 39 degree, a sector 11 at 27 degree, a sector 12 at 24 degree and a sector 13 at 36 degree, the 13 sectors are subdivided into 4 circular regions based on the pupil, and each circular region called as a sector 1-4, a sector 1-3, a sector 1-2 and a sector 1-1.

29. The method as recited in claim 26, wherein in said step a), an eye image appropriate for the iris recognition is captured through an image selection process having an eye blink detection, a pupil location detection, and distribution of vertical edge components, after digitalizing and quantizing the eye image.

30. The method as recited in claim 29, wherein said step b) includes the steps of:
removing edge noise based on an edge enhancing diffusion (EED) algorithm using a diffusion filter;
diffusing the iris image by performing a Gaussian blurring; and
changing a threshold used for binalizing the iris image based on a magnified maximum coefficients algorithm, to thereby obtain an actual center point of the pupil.

31. The method as recited in claim 30, wherein the EED algorithm performs much diffusion in the same direction with the edge and smaller diffusion in the vertical direction to the edge.

32. The method as recited in claim 29, wherein said step d) includes steps of:
detecting a pupil by obtaining a pupil boundary between the pupil and the iris, a radius of the circle and coordinates of the center point of the pupil and determining the location and the size of the pupil; and
detecting an outer boundary between the iris and a sclera based on arcs which are not necessarily concentric with the pupil boundary,
wherein the pupil is detected in real time iteratively changing the threshold, since the curvature of the pupil is different, a radius of the pupil is obtained by a magnified maximum coefficients algorithm, coordinates of the center point of the pupil are obtained by a bisecting algorithm, a distance between the center point and the radius of the pupil in counterclockwise is obtained, and a graph is illustrated in which x-axis denotes a rotation angle and y-axis denotes the radius of the pupil, to thereby detect an accurate boundary.

33. The method as recited in claim 32, wherein said step e) includes the steps of:
performing 1-order scale-space filtering that provides the same pattern regardless of the size of the iris pattern image by using a Gaussian cannel with respect to a one-dimensional iris pattern image of the same radiuses around the pupil;
obtaining an edge, which is a zero-crossing point; and
extracting the iris features in two-dimensional by accumulating the edge by using an overlapped convolution window,
wherein the size of data is reduced during the generation of an iris code.

34. The method as recited in claim 33, wherein in said step f), the moment is normalized into a mean size based on a low-order moment in order to obtain a feature quantity, to thereby generate a Zernike moment which is rotation-invariant but sensitive to size and illumination of the image into a Zernike moment which is size-invariant, and the moment is normalized into a mean brightness, if a change in a local illumination is modeled into a scale illumination change, to thereby generate a Zernike moment which is illumination-invariant.

35. A method for recognizing an iris, comprising the steps of:
a) digitalizing and quantizing an image and obtaining an appropriate image for iris recognition;
b) detecting reference points in a pupil from the image, and detecting an actual center point of the pupil;
c) detecting an inner boundary between the pupil and the iris and an outer boundary between the iris and a sclera, to thereby extract an iris image from the image;
d) converting a coordinates of the iris image from a Cartesian coordinates system to a polar coordinates system, and defining the center point of the pupil as an origin point of the polar coordinates system,
e) classifying analysis regions of the iris image in order to use an iris pattern as a feature point based on clinical experiences of the iridology;
f) smoothing the image by performing a scale space filtering of the analysis region of the iris image in order to clearly distinguish a brightness distribution difference between neighboring pixels of the image;
g) normalizing a low-order moment used for the smoothen image as a mean size;
h) generating a Zernike moment based on the feature point extracted in a scale space and a scale illumination, and extracting a shape descriptor which is rotation-invariant and noise-resistant by using Zernike moment;
i) storing a reference value as a template by comparing a stability of the Zernike moment and a similarity of Euclid distance; and
j) verifying/authenticating the iris by matching the feature quantities between models each of which represent the stability and the similarity of the Zernike moment of the query iris image in statistical.

36. The method as recited in claim 35, wherein said verification means recognizes the iris based on a least square (LS) algorithm and a least media of square (LmedS) algorithm, to thereby recognize the iris rapidly and precisely,
wherein filtering of the moment of the image is performed based on the similarity and the stability used for probability object recognition and matches the stored reference value moment to a local-space in order to obtain an outlier,
wherein the outlier allows the system to confirm or disconfirm the identification of the person and evaluate confirm level of the decision,
wherein a recognition rate is obtained by discriminative factor (DF), the DF has a high recognition ability when a matching number of the input image and the right model is more than a matching number of the input image and the wrong model.

37. A computer readable recording medium storing program for executing a method for detecting a pupil for iris recognition, the method comprising the steps of:
a) detecting light sources in the pupil from an eye image as two reference points;
b) determining first boundary candidate points located between the iris and the pupil of the eye image, which cross over a straight line between the two reference points;
c) determining second boundary candidate points located between the iris and the pupil of the eye image, which cross over a perpendicular bisector of a straight line between the first boundary candidate points; and
d) determining a location and a size of the pupil by obtaining a radius of a circle and coordinates of a center of the circle based on a center candidate point, wherein the center candidate point is a center point of perpendicular bisectors of straight line between the neighbor boundary candidate points, to thereby detect the pupil.

38. A computer readable recording medium storing program for executing a method for extracting a shape descriptor for iris recognition, the method comprising the steps of:
a) extracting a feature of an iris under a scale-space and/or a scale illumination;
b) normalizing a low-order moment with a mean size and/or a mean illumination, to thereby generate a Zernike moment which is size-invariant and/or illumination-invariant, based on the low-order moment; and
c) extracting a shape descriptor which is rotation-invariant, size-invariant and/or illumination-invariant, based on the Zernike moment.

39. The computer readable recording medium as recited in claim 38, the method further comprising the steps of:
establishing an indexed iris shape grouping database based on the shape descriptor; and
retrieving an indexed iris shape group based on an iris shape descriptor similar to that of a query image from the indexed iris shape grouping database.

40. A computer readable recording medium storing program for executing a method for extracting a feature of an iris, the method comprising the steps of:
a) digitalizing and quantizing an image and obtaining an appropriate image for iris recognition;
b) detecting reference points in a pupil from the image, and detecting an actual center point of the pupil;
c) detecting an inner boundary between the pupil and the iris and an outer boundary between the iris and a sclera, to thereby extract an iris image from the image;
d) converting a coordinates of the iris image from a Cartesian coordinates system to a polar coordinates system, and defining the center point of the pupil as an origin point of the polar coordinates system;
e) classifying analysis regions of the iris image in order to use an iris pattern as a feature point based on clinical experiences of the iridology;
f) smoothing the image by performing a scale space filtering of the analysis region of the iris image in order to clearly distinguish a brightness distribution difference between neighboring pixels of the image;
g) normalizing a low-order moment used for the smoothen image as a mean size; and
h) generating a Zernike moment based on the feature point extracted in a scale space and a scale illumination, and extracting a shape descriptor which is rotation-invariant and noise-resistant by using Zernike moment.

41. The computer readable recording medium as recited in claim 40, the method further comprising the step of:
i) storing a reference value as a template by comparing a stability of the Zernike moment and a similarity of Euclid distance.

42. A computer readable recording medium storing program for executing a method for recognizing an iris, the method comprising the steps of:
a) digitalizing and quantizing an image and obtaining an appropriate image for iris recognition;
b) detecting reference points in a pupil from the image, and detecting an actual center point of the pupil;
c) detecting an inner boundary between the pupil and the iris and an outer boundary between the iris and a sclera, to thereby extract an iris image from the image;
d) converting a coordinates of the iris image from a Cartesian coordinates system to a polar coordinates system, and defining the center point of the pupil as an origin point of the polar coordinates system;
e) classifying analysis regions of the iris image in order to use an iris pattern as a feature point based on clinical experiences of the iridology;
f) smoothing the image by performing a scale space filtering of the analysis region of the iris image in order to clearly distinguish a brightness distribution difference between neighboring pixels of the image;
g) normalizing a low-order moment used for the smoothen image as a mean size;
h) generating a Zernike moment based on the feature point extracted in a scale space and a scale illumination, and extracting a shape descriptor which is rotation-invariant and noise-resistant by using Zernike moment;
i) storing a reference value as a template by comparing a stability of the Zernike moment and a similarity of Euclid distance; and
j) verifying/authenticating the iris by matching the feature quantities between models each of which represent the stability and the similarity of the Zernike moment of the query iris image in statistical.

43. The method as recited in claim 4, wherein since the curvature of the pupil is different, a radius of the pupil is obtained by a magnified maximum coefficients algorithm, coordinates of the center point of the pupil are obtained by a bisecting algorithm, a distance between the center point and the radius of the pupil in counterclockwise is obtained, and a graph is illustrated in which x-axis denotes a rotation angle and y-axis denotes the radius of the pupil.

44. The apparatus as recited in claim 12, wherein said image capturing means captures an eye image appropriate for the iris recognition through an image selection process having an eye blink detection, a pupil location detection, and distribution of vertical edge components, after digitalizing and quantizing the eye image.

45. The apparatus as recited in claim 13, wherein said image capturing means captures an eye image appropriate for the iris recognition through an image selection process having an eye blink detection, a pupil location detection, and distribution of vertical edge components, after digitalizing and quantizing the eye image.

46. The system as recited claim 23, wherein in extraction of a shape descriptor,
an image appropriate for an iris recognition is obtained through a digital camera, reference points in the pupil are detected, a pupil boundary between the pupil and the iris is defined, and an outer boundary between the iris and a sclera is detected based on arcs which are not necessarily concentric with the pupil boundary;
1-order scale-space filtering, which provides the same pattern regardless of the size of the iris pattern image by using a Gaussian cannel with respect to a one-dimensional iris pattern image of the same radiuses around the pupil is performed, an edge, which is a zero-crossing point, is obtained, and the iris features in two-dimensional is extracted by accumulating the edge by using an overlapped convolution window;
the moment is normalized into a mean size based on a low-order moment in order to obtain a feature quantity, to thereby generate a Zernike moment which is rotation-invariant but sensitive to size and illumination of the image into a Zernike moment which is size-invariant, and the moment is normalized into a mean brightness, if a change in a local illumination is modeled into a scale illumination change, to thereby generate a Zernike moment which is illumination-invariant.

47. The system as recited claim 24, wherein in extraction of a shape descriptor,
an image appropriate for an iris recognition is obtained through a digital camera, reference points in the pupil are detected, a pupil boundary between the pupil and the iris is defined, and an outer boundary between the iris and a sclera is detected based on arcs which are not necessarily concentric with the pupil boundary;
1-order scale-space filtering, which provides the same pattern regardless of the size of the iris pattern image by using a Gaussian cannel with respect to a one-dimensional iris pattern image of the same radiuses around the pupil is performed, an edge, which is a zero-crossing point, is obtained, and the iris features in two-dimensional is extracted by accumulating the edge by using an overlapped convolution window;
the moment is normalized into a mean size based on a low-order moment in order to obtain a feature quantity, to thereby generate a Zernike moment which is rotation-invariant but sensitive to size and illumination of the image into a Zernike moment which is size-invariant, and the moment is normalized into a mean brightness, if a change in a local illumination is modeled into a scale illumination change, to thereby generate a Zernike moment which is illumination-invariant.

48. The method as recited in claim 27, wherein the analysis region includes the image except an eyelid, eyelashes or a predetermined part that is blocked off by mirror reflection from illumination, and
wherein the analysis region is subdivided into a sector 1 at right and left 6 degree based on the 12 clock direction, a sector 2 at 24 degrees, in the clock-wise, a sector 3 at 42 degree, a sector 4 at 9 degree, a sector 5 at 30 degree, a sector 6 at 42 degree, a sector 7 at 27 degree, a sector 8 at 36 degree, a sector 9 at 18 degree, a sector 10 at 39 degree, a sector 11 at 27 degree, a sector 12 at 24 degree and a sector 13 at 36 degree, the 13 sectors are subdivided into 4 circular regions based on the pupil, and each circular region called as a sector 1-4, a sector 1-3, a sector 1-2 and a sector 1-1.

49. The method as recited in claim 27, wherein in said step a), an eye image appropriate for the iris recognition is captured through an image selection process having an eye blink detection, a pupil location detection, and distribution of vertical edge components, after digitalizing and quantizing the eye image.
